(19) United States
(12) Patent Application Publication
(10) Pub. No.: US 2025/0259517 A1
(43) Pub. Date: Aug. 14, 2025

(54) VIBRATION PROCESSING METHOD AND RELATED DEVICE

(71) Applicant: Tencent Technology (Shenzhen) Company Limited, Shenzhen (CN)

(72) Inventors: Shili Xu, Shenzhen (CN); Zhuan Liu, Shenzhen (CN); Jianing Zhao, Shenzhen (CN); Kai Hong, Shenzhen (CN)

(21) Appl. No.: 19/191,295

(22) Filed: Apr. 28, 2025

Related U.S. Application Data
(63) Continuation of application No. PCT/CN2024/080315, filed on Mar. 6, 2024.

(30) Foreign Application Priority Data
Apr. 11, 2023 (CN) 202310380081.1

(51) Int. Cl. G08B 6/00; A63F 13/285

(52) U.S. Cl. CPC G08B 6/00; A63F 13/285

(57) ABSTRACT

A vibration processing method and a computing device are provided. The method includes: obtaining a current vibration fragment and coded information of the current vibration fragment from a vibration file of media data, where the vibration file includes one or more vibration fragments, each vibration fragment corresponds to a media fragment of the media data, and the coded information of the current vibration fragment is configured for identifying a position of the current vibration fragment in the vibration file; and controlling to output a current vibration based on the coded information of the current vibration fragment, where when the current vibration is outputted, a media fragment corresponding to the current vibration fragment is outputted. As such, synchronization between vibrations and media can be ensured as much as possible, and immersive experience can be enhanced.

### RELATED APPLICATIONS

This application is a continuation application of PCT Patent Application No. PCT/CN2024/080315, filed on Mar. 6, 2024, which claims priority to Chinese Patent Application No. 202310380081.1, filed on Apr. 11, 2023, each entitled “VIBRATION PROCESSING METHOD AND RELATED DEVICE,” and each of which is incorporated herein by reference in its entirety.

### FIELD

The present disclosure relates to the field of computer technologies, and in particular, to a vibration processing method, a vibration processing apparatus, a computer device, a computer-readable storage medium, and a computer program product.

### BACKGROUND

As a new output media, a vibration is widely applied to various service scenes (such as a game interaction scene and an audio/video play scene). Synchronously playing vibration and media (for example, audio or a video) can create more immersive experience and provide consistency in feelings in multi-dimensions for an object.

Currently, designs related to vibration effects are more complex and diversified. In a process of playing the vibration and the corresponding media, the vibration (for example, a motor vibration) performed by a mechanical apparatus and the media may be asynchronous, and asynchronization is exacerbated as time accumulates and is sensed by the object. In this way, experience of the object in a corresponding service scene is affected. Therefore, how to ensure synchronization between the vibration and the media as much as possible is a problem to be resolved urgently.

### SUMMARY

Embodiments of the present disclosure provide a vibration processing method and a related device, to ensure synchronization between a vibration and media as much as possible, thereby bringing more immersive experience.

In one aspect, an embodiment of the present disclosure provides a vibration processing method. The method includes:
obtaining a current vibration fragment and coded information of the current vibration fragment from a vibration file of media data, where the vibration file includes one or more vibration fragments, any vibration fragment corresponds to a media fragment of the media data, and the coded information of the current vibration fragment is configured for identifying a position of the current vibration fragment in the vibration file; and
controlling to output a current vibration based on coded information of a current vibration fragment, where when the current vibration is outputted, a media fragment corresponding to the current vibration fragment is outputted.

In one aspect, an embodiment of the present disclosure provides a vibration processing apparatus. The apparatus includes:
an obtaining unit, configured to obtain a current vibration fragment and coded information of the current vibration fragment from a vibration file of media data, where the vibration file includes one or more vibration fragments, any vibration fragment corresponds to a media fragment of the media data, and the coded information of the current vibration fragment is configured for identifying a position of the current vibration fragment in the vibration file; and
a control unit, configured to control to output a current vibration based on the coded information of the current vibration fragment, where when the current vibration is outputted, a media fragment corresponding to the current vibration fragment is outputted.

In one aspect, an embodiment of the present disclosure provides a computer device. The computer device includes:
a processor, adapted to execute a computer program; and
a computer-readable storage medium, where the computer-readable storage medium has a computer program stored therein, and the computer program, when executed by the processor, implementing the foregoing vibration processing method.

In one aspect, an embodiment of the present disclosure provides a computer-readable storage medium. The computer-readable storage medium has a computer program stored therein. The computer program is loaded by a processor to perform the foregoing vibration processing method.

In one aspect, an embodiment of the present disclosure provides a computer program product. The computer program product includes a computer program or computer instructions. The computer program or the computer instructions, when executed by a processor, implement the foregoing vibration processing method.

In this embodiment of the present disclosure, a current vibration fragment and coded information of the current vibration fragment may be obtained from a vibration file of media data. The vibration file includes one or more vibration fragments, and one vibration fragment corresponds to a media fragment of the media data. It can be seen that there is a correspondence between vibration fragments in the vibration file and media fragments in the media data. The correspondence may ensure that the vibration fragments are conforming to the media fragments. The coded information of the current vibration fragment may be configured for identifying a position of the current vibration fragment in the vibration file, a current vibration may be controlled to be outputted based on the coded information of the current vibration fragment, and when the current vibration is outputted, a media fragment corresponding to the current vibration fragment may be outputted. It can be seen that output of the corresponding vibration of the current vibration fragment may be controlled based on the coded information of the current vibration fragment, and the current vibration and the corresponding media fragment are synchronously outputted. If the vibration file includes a plurality of vibration fragments, the vibration output is fragmented, and vibrations corresponding to the vibration fragments in the vibration file can be synchronously outputted with the corresponding media fragments under an indication of the coded information. In addition, the output of the corresponding vibration may be flexibly controlled based on the coded information for vibration fragments at different positions in the vibration file. The vibration of each fragment is synchronized with the output of the media fragment, so that synchronization of overall vibration and media can be ensured, thereby providing more immersive experience for an object.

### BRIEF DESCRIPTION OF THE DRAWINGS

FIG. 1 is an architectural diagram of a vibration processing system according to an embodiment of the present disclosure.

FIG. 2 is a schematic flowchart of a vibration processing method according to an embodiment of the present disclosure.

FIG. 3a is a schematic diagram of a relationship between media data and vibration files according to an embodiment of the present disclosure.

FIG. 3b is a schematic diagram of a correspondence between vibration fragments and media fragments according to an embodiment of the present disclosure.

FIG. 3c is a schematic diagram of a position of a current vibration fragment in a vibration file according to an embodiment of the present disclosure.

FIG. 4 is a schematic flowchart of another vibration processing method according to an embodiment of the present disclosure.

FIG. 5a is a schematic diagram of determining a synchronization time stamp in an audio synchronization scene according to an embodiment of the present disclosure.

FIG. 5b is a schematic diagram of determining a synchronization time stamp in a game scene according to an embodiment of the present disclosure.

FIG. 5c is a schematic diagram of vibration synchronization control logic according to an embodiment of the present disclosure.

FIG. 5d is a schematic diagram of content of coded information of a current vibration fragment according to an embodiment of the present disclosure.

FIG. 6 is a schematic structural diagram of a vibration processing apparatus according to an embodiment of the present disclosure.

FIG. 7 is a schematic structural diagram of a computer device according to an embodiment of the present disclosure.

### DETAILED DESCRIPTION

The terms “first”, “second”, and the like in the present disclosure are configured for distinguishing the same or similar items that perform substantially the same function. The terms “first”, “second”, and “n^{th}” do not have a logical or chronological dependency on each other or limit the number and order of execution.

In the present disclosure, the term “at least one” means one or more, and “a plurality of” means two or more. For example, at least one vibration fragment means one, two, or more vibration fragments. A plurality of vibration fragments mean two or more vibration fragments.

The present disclosure provides a vibration processing scheme. The scheme relates to a vibration processing system and method, and a related device. The scheme may be performed by a computer device. The computer device may first obtain a vibration file including one or more vibration fragments, where the vibration file corresponds to media data. Then a current vibration fragment may be obtained from the vibration file of the media data, where any vibration fragment in the vibration file corresponds to a media fragment in the media data. The computer device may further obtain coded information of the current vibration fragment. The coded information may be configured for identifying a position of the current vibration fragment in the vibration file. A current vibration may be controlled to be outputted based on the coded information, and when the current vibration is outputted, a media fragment corresponding to the current vibration fragment may be outputted. In this way, a corresponding media fragment may further be outputted at a moment at which the current vibration is outputted, so that the current vibration and the media fragment may be synchronously outputted. If the vibration file includes a plurality of vibration fragments, the vibration output is fragmented. In this way, vibrations corresponding to the vibration fragments in the vibration file can be synchronously outputted with the corresponding media fragments, so as to ensure synchronization between the entire vibration and the media, thereby providing more immersive experience for an object.

The vibration processing scheme provided in the present disclosure may be applied to various service scenes. The service scenes include but are not limited to: a game scene, a video play scene, an audio play scene, and the like. In the corresponding service scene, vibration and media play are kept as synchronous as possible, thereby bringing better service experience. For example, in the game scene, by using the vibration processing scheme of the present disclosure, a vibration may be synchronized with audio and/or video in the game scene as much as possible. For example, when a virtual character releases a striking operation in the game scene, a vibration may be outputted at the same time. Thus, an operator can feel the vibration that is synchronously outputted. In this way, a more vivid striking feeling can be created for the operator, and smoother control experience can be brought to the operator. In addition, synchronization between the vibration, the audio, and the video in the game scene can further bring consistency of a tactile sense, an auditory sense, and a visual sense to the operator, thereby providing more immersive game experience. Schematically, in the video play scene, by using the vibration processing scheme of the present disclosure, vibration and a video picture can be synchronized as much as possible, and perception of tactile and visual dimensions are combined, to create more immersive watching experience for a viewer. Schematically, in the audio play scene, vibration and audio rhythms may be kept as synchronous as possible by using the vibration processing scheme of the present disclosure, and better music experience is created for followers by the perception of the tactile and auditory dimensions.

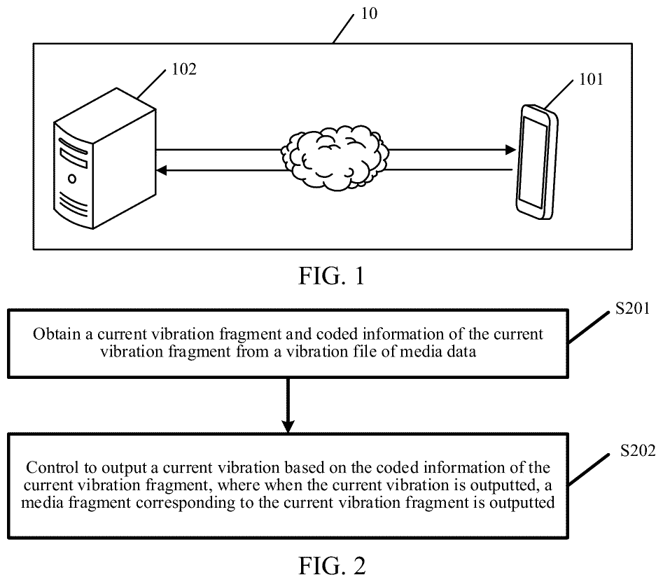

Referring to FIG. 1, FIG. 1 is an architectural diagram of a vibration processing system according to an exemplary embodiment of the present disclosure. As shown in FIG. 1, the vibration processing system 10 includes a terminal device 101 and a server 102. The terminal device 101 may communicate with the server 102 in a wired or wireless mode.

The terminal device 101 includes but is not limited to: a smartphone, a tablet computer, an intelligent wearable device, an intelligent voice interaction device, an intelligent appliance, a personal computer, an in-vehicle terminal, an intelligent camera, or another device. This is not limited in the present disclosure. A quantity of terminal devices is not limited in the present disclosure. The server 102 may be, but is not limited to, an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. A quantity of servers is not limited in the present disclosure.

The vibration processing procedure performed by the terminal device 101 may roughly include the following processing content: (1) Obtain a current vibration fragment. (2) Obtain coded information of the current vibration fragment. (3) Control output of a current vibration.

### (1) Obtain a Current Vibration Fragment.

The terminal device may obtain a current vibration fragment from a vibration file of media data. The vibration file includes one or more vibration fragments. The current vibration fragment is one of the vibration fragments.

In one embodiment, the terminal device may first obtain a vibration file of media data. The vibration file is a file that records a continuous vibration. The terminal device may determine a synchronization time stamp according to the media data, and split the vibration file by using the synchronization time stamp, to obtain a plurality of vibration fragments of the vibration file. And a current vibration fragment is obtained from the plurality of vibration fragments in the vibration file in sequence. As a feasible mode, the foregoing content may alternatively be performed by the server, and the terminal device may directly obtain a vibration fragment in the vibration file from the server as the current vibration fragment. In another embodiment, the vibration file may not be split. To be specific, the vibration file includes only one vibration fragment. The vibration fragment included is a current vibration fragment. The current vibration fragment corresponds to a complete continuous vibration.

### (2) Obtain Coded Information of the Current Vibration Fragment.

Each vibration fragment in the vibration file corresponds to respective coded information. In an implementation, if the terminal device splits the vibration file, the terminal device may code each vibration fragment to obtain coded information of each vibration fragment. After obtaining a current vibration fragment, the terminal device may further obtain coded information of the current vibration fragment. In another implementation, coded information of each vibration fragment may alternatively be stored in the server. After obtaining a current vibration fragment from the server, the terminal device may further obtain coded information of the current vibration fragment from the server.

The coded information of the current vibration fragment may be configured for identifying a position of the current vibration fragment in the vibration file. If the vibration file includes a plurality of vibration fragments, positions identified by coded information of vibration fragments at different positions in the vibration file are different.

### (3) Control to Output a Current Vibration Based on the Coded Information.

In addition to being configured for identifying a position of the current vibration fragment in the vibration file, the coded information of the current vibration fragment may further include a parameter that describes a vibration corresponding to the current vibration fragment, to describe an effect of the vibration. The parameter includes but is not limited to: a vibration intensity, a vibration frequency, a vibration duration, a vibration start time stamp, and the like. The terminal device may parse the coded information, and control to output a current vibration (i.e. the vibration corresponding to the current vibration fragment) according to an indication of the parsed coded information. And when the current vibration is outputted, a corresponding media fragment may be outputted. In this way, the media fragment in the media data and the current vibration start to be outputted at the same time, so as to synchronize the current vibration with the media fragment. The vibration corresponding to each vibration fragment in the vibration file and the media fragment corresponding to the corresponding vibration fragment are outputted at the same time. Synchronization between a continuous vibration and media may be implemented by synchronizing each vibration fragment with the media fragment.

In an implementable mode, the procedure described in (1) to (3) may alternatively be performed by the server, or by the server and the terminal device jointly. For example, when the server and the terminal device jointly perform the procedure, the server may issue a control instruction to control the terminal device to output a current vibration, and output a corresponding media fragment when outputting the current vibration, so as to synchronously output the vibration and the media.

According to the vibration processing scheme provided in this embodiment of the present disclosure, a current vibration fragment and coded information of the current vibration fragment may be obtained from a vibration file of media data. The vibration file includes one or more vibration fragments, and one vibration fragment corresponds to a media fragment of the media data. It can be seen that there is a correspondence between vibration fragments in the vibration file and media fragments in the media data. The correspondence may ensure that the vibration fragments are conforming to the media fragments. The coded information of the current vibration fragment may be configured for identifying a position of the current vibration fragment in the vibration file, a current vibration may be controlled to be outputted based on the coded information of the current vibration fragment, and when the current vibration is outputted, a media fragment corresponding to the current vibration fragment may be outputted. In this way, output of the corresponding vibration of the current vibration fragment may be controlled based on the coded information of the current vibration fragment, and the current vibration and the corresponding media fragment are synchronously outputted. Further, if the vibration file includes a plurality of vibration fragments, the vibration output is fragmented, and vibrations corresponding to the vibration fragments in the vibration file can be synchronously outputted with the corresponding media fragments under an indication of the coded information. In addition, the output of the corresponding vibration may be flexibly controlled based on the coded information for vibration fragments at different positions in the vibration file. The vibration of each fragment is synchronized with the output of the media fragment, so that synchronization of a continuous vibration and media can be ensured, thereby providing more immersive experience for an object.

FIG. 2 is a schematic flowchart of a vibration processing method according to an embodiment of the present disclosure. The vibration processing method may be performed by a computer device (for example, the terminal device 101 in the system shown in FIG. 1). The vibration processing method may include the following operations S201 to S202.

S201: Obtain a current vibration fragment and coded information of the current vibration fragment from a vibration file of media data.

The media data may be configured for representing media. The media data supports outputting. In the field of computers, the media data includes, but is not limited to, data of one or more types of media such as a text, an image, audio, an animation, and video. Schematically, the media data includes, but is not limited to: video data, audio data, game data, and the like. In an implementation, the media data may be a data stream. The data stream is a data form that continuously provides content to an object. The data stream includes, but is not limited to: one or more of a video stream, an audio stream, a text data stream, an image data stream, and the like. With the help of a modern communication network, media data can be transmitted by using a corresponding medium (for example, broadcast, television, and network) as a carrier.

The vibration file of the media data may be configured for recording a continuous vibration. The continuous vibration means an uninterrupted vibration within a period of time. Through conformity between the media data and the continuous vibration, play experience in different dimensions can be brought within a same time period. For example, the media data represents a video from 0 to 10 seconds. A continuous vibration exists at the 5^{th} second of the video in cooperation with a change of a video picture, and the vibration duration is set to 2 seconds. Then the vibration file of the video may record a continuous vibration of 2 seconds. The continuous vibration recorded in the vibration file includes a description of a vibration effect of the continuous vibration. To be specific, how to vibrate may be described by using the vibration file. For example, the vibration is performed according to a vibration intensity, a vibration frequency, and a vibration duration. Therefore, in this embodiment of the present disclosure, the vibration file may alternatively be referred to as a vibration effect file or a vibration effect description file.

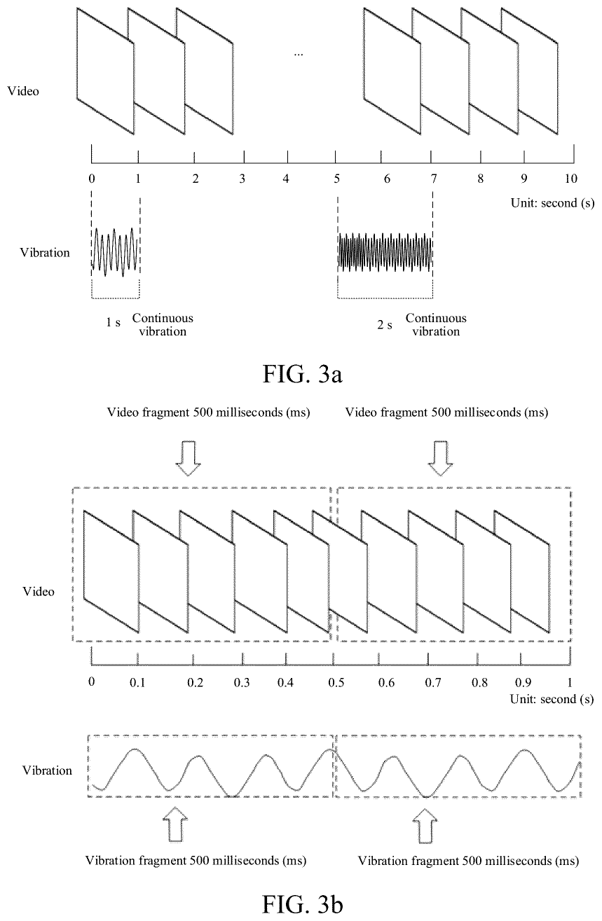

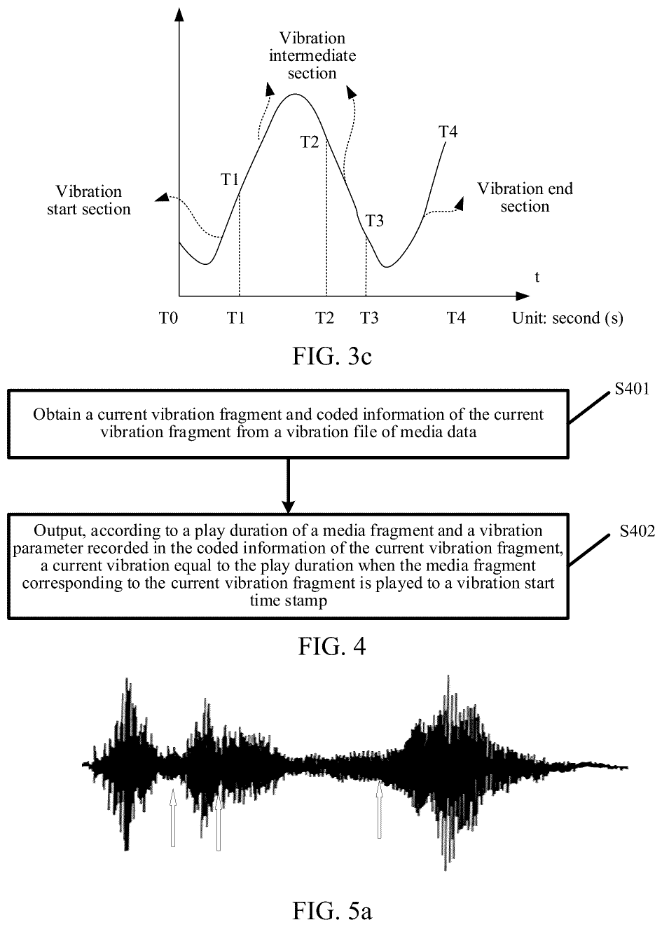

The media data may correspond to one or more continuous vibrations. When the media data may correspond to a plurality of vibration files, continuous vibrations recorded by different vibration files are discontinuous. For example, refer to a schematic diagram of a relationship between media data and vibration files shown in FIG. 3a. Still for the foregoing video from 0 to 10 seconds, the video may correspond to one continuous vibration in the 0^{th} second to the 1^{st} second, and correspond to one continuous vibration in the 5^{th} second to the 7^{th} second. Therefore, the media data corresponds to two vibration files respectively recording two continuous vibrations. For ease of understanding, in this embodiment of the present disclosure, one vibration file of the media data is used as an example for description. If there are a plurality of vibration files of the media data, the vibration processing method described in this embodiment of the present disclosure may be applied to each vibration file, to ensure synchronization between the continuous vibration recorded in the vibration file and the media data.

The vibration file includes one or more vibration fragments, and any vibration fragment corresponds to a media fragment of the media data. If the vibration file includes only one vibration fragment, a vibration corresponding to the vibration fragment is a continuous vibration recorded in the vibration file. A media fragment corresponding to the vibration fragment is media represented by reference media data corresponding to the continuous vibration. The reference media data may be all media data or some media data. If the vibration file includes a plurality of vibration fragments, a vibration outputted based on one vibration fragment is a fragment of vibration of the continuous vibration. All vibration fragments may be combined in sequence to correspond to the continuous vibration recorded in the vibration file. A media fragment corresponding to the vibration fragment is a part of media corresponding to the media data. Based on a correspondence between vibration fragments and media fragments, the media fragment may be outputted when the corresponding vibration is outputted, so that the vibration conforms to the media fragment, thereby ensuring a synchronization effect. For example, refer to a schematic diagram of a correspondence between vibration fragments and media fragments shown in FIG. 3b. Based on the continuous vibration shown in FIG. 3a, a continuous vibration corresponding to a 0-1 second video picture in a video is divided into two fragments of vibration. The vibration file includes two vibration fragments. A vibration duration corresponding to one vibration fragment is 500 milliseconds (ms), and one vibration fragment corresponds to one video fragment of 500 ms. If the continuous vibration is not fragmented, the vibration file includes only one vibration fragment. A vibration duration corresponding to the vibration fragment is 1 second(s), and corresponds to a video fragment of 0-1 s in a video of 10 s.

The current vibration fragment is a vibration fragment obtained from the one or more vibration fragments included in the vibration file of the media data. The current vibration fragment may be a vibration fragment that is being processed. The coded information of the current vibration fragment is obtained by coding the current vibration fragment. The coded information of the current vibration fragment is configured for identifying a position of the current vibration fragment in the vibration file. In an implementation, if the vibration file includes only one vibration fragment, a position of the current vibration fragment in the vibration file may be configured for indicating an effect that the continuous vibration is an independent vibration. The vibration corresponding to the current vibration fragment is not connected to other continuous vibrations before and after. If the vibration file includes a plurality of vibration fragments, the position of the current vibration fragment in the vibration file may include any one of the following: a vibration start section, a vibration intermediate section, and a vibration end section. The position of the current vibration fragment is based on a fragment of vibration outputted by the current vibration fragment, relative to the continuous vibration recorded in the vibration file. When the current vibration fragment is at the vibration start section, a vibration fragment is further connected after the current vibration fragment. When the current vibration fragment is at the vibration intermediate section, vibration fragments are connected before and after the current vibration fragment. When the current vibration fragment is at the vibration end section, a vibration fragment is connected before the current vibration fragment. Schematically, FIG. 3c shows a schematic diagram of a position of a current vibration fragment in a vibration file. A continuous vibration (T0-T4) recorded in the vibration file is split into four fragments by using three time stamps T1, T2, and T3. Therefore, the vibration file includes four vibration fragments, which may be respectively configured for describing: vibration fragments T0-T1, T1-T2, T2-T3, and T3-T4. The vibration fragment T0-T1 is at the vibration start section of the vibration file. The two vibration fragments T1-T2 and T2-T3 are at the vibration intermediate section of the vibration file. The vibration fragment T3-T4 is at the vibration end section of the vibration file. The current vibration fragment may be any one vibration fragment of the foregoing four vibration fragments.

The position of the current vibration fragment in the vibration file is identified by using coded information, so that whether the vibration file is divided into a plurality of vibration fragments may be learned, and the recorded continuous vibration is fragmented vibration based on the vibration fragments. When the vibration file is divided into a plurality of vibration fragments, a corresponding processing policy can be configured for controlling vibration output based on the position of the current vibration fragment in the entire vibration file, to implement continuity between fragmented vibrations and synchronization between the continuous vibration and the media (for example, audio/video).

S202: Control to output a current vibration based on coded information of a current vibration fragment. When the current vibration is outputted, a media fragment corresponding to the current vibration fragment is outputted.

In addition to identifying a position of a current vibration code in the vibration file, the coded information of the current vibration fragment may further include other parameters to indicate information needed by the vibration of the current vibration fragment, for example, a vibration duration, a vibration intensity, and a vibration frequency of the current vibration, so as to vibrate based on the coded information.

The current vibration may be controlled to be outputted based on the position identified by the coded information of the current vibration fragment and an indication that the coded information includes other parameters. The current vibration is a vibration corresponding to the current vibration fragment. If the current vibration fragment is the only vibration fragment in the vibration file, the current vibration that is controlled to be outputted is the continuous vibration recorded in the vibration file. If the current vibration fragment is one vibration fragment in the plurality of vibration fragments, the current vibration that is controlled to be outputted is a fragment of vibration of the continuous vibration. As a feasible implementation, the current vibration outputted based on the current vibration fragment may include a plurality of vibration stages, for example, a vibration start, a vibration-in-process, and a vibration end. At different stages of the current vibration, corresponding processing policies may be used based on the position of the current vibration fragment in the vibration file, to implement continuity between vibrations, thereby ensuring that the vibrations are outputted more smoothly.

Further, when the current vibration is outputted, a media fragment corresponding to the current vibration fragment may be outputted. For example, when the current vibration is outputted, a video from 0^{th} to 1^{st} s may be outputted. In this way, it can be ensured that the current vibration and the media fragment are synchronously outputted. In this embodiment of the present disclosure, output of the vibration/media fragment may be playing of the vibration/media fragment. If the vibration file includes a plurality of vibration fragments, each time a media fragment is played, a vibration corresponding to the media fragment may be correspondingly outputted. By synchronously outputting each vibration and the media fragment, the continuous vibration recorded by the vibration file and the media (for example, audio/video) represented by the media data may be synchronized as much as possible at each time point, thereby achieving a better synchronization effect.

According to the vibration processing method provided in this embodiment of the present disclosure, a current vibration fragment and coded information of the current vibration fragment may be obtained from a vibration file of media data. The vibration file includes one or more vibration fragments, and one vibration fragment corresponds to a media fragment of the media data. It can be seen that there is a correspondence between vibration fragments in the vibration file and media fragments in the media data. The correspondence may ensure that the vibration fragments are conforming to the media fragments. The coded information of the current vibration fragment may be configured for identifying a position of the current vibration fragment in the vibration file, a current vibration may be controlled to be outputted based on the coded information of the current vibration fragment, and when the current vibration is outputted, a media fragment corresponding to the current vibration fragment may be outputted. It can be seen that output of the corresponding vibration of the current vibration fragment may be controlled based on the coded information of the current vibration fragment, and the current vibration and the corresponding media fragment are synchronously outputted. Further, if the vibration file includes a plurality of vibration fragments, the vibration output is fragmented, and vibrations corresponding to the vibration fragments in the vibration file can be synchronously outputted with the corresponding media fragments under an indication of the coded information. In addition, the output of the corresponding vibration may be flexibly controlled based on the coded information for vibration fragments at different positions in the vibration file. The vibration of each fragment is synchronized with the output of the media fragment, so that synchronization of overall vibration and media can be ensured, thereby providing more immersive experience for an object.

FIG. 4 is a schematic flowchart of another vibration processing method according to an embodiment of the present disclosure. The vibration processing method may be performed by a computer device (for example, the terminal device 101 in the system shown in FIG. 1). The vibration processing method may include the following operations S401 to S402.

S401: Obtain a current vibration fragment and coded information of the current vibration fragment from a vibration file of media data.

In one embodiment, a mode of obtaining a plurality of vibration fragments included in the vibration file may include the following operations 1 to 3.

### Operation 1: Obtain a Vibration File of Media Data.

The vibration file is a file that records a continuous vibration. The continuous vibration means an uninterrupted vibration within a period of time. One or more vibration files of the media data may be obtained based on the vibration set for the media data. For example, audio of one minute corresponds to three continuous vibrations, and the vibrations are outputted in different time periods of the audio. Therefore, three vibration files of the media data may be obtained. For ease of description, in this embodiment of the present disclosure, a vibration file of media data is used as an example for description.

Operation 2: Determine One or More Synchronization Time Stamps of the Vibration File from the Media Data.

The vibration file may record a vibration state (such as a vibration intensity and a vibration frequency) of the continuous vibration at each time stamp. The synchronization time stamp determined herein may be a start time stamp when the vibration file records the continuous vibration, or may be a time stamp between a start time stamp and an end time stamp when the vibration file records the continuous vibration. Synchronization calibration may be performed on the outputted current vibration and media data each time after a synchronization time stamp. In this way, synchronization between vibration and media play may be ensured as much as possible by using one or more synchronization time stamps.

In one embodiment, the operation of determining one or more synchronization time stamps of the vibration file from the media data may include the following operations 2.1 to 2.3.

Operation 2.1: Align the Vibration File with the Media Data According to a Vibration Start Time Stamp of the Media Data.

The vibration start time stamp of the media data is a time stamp when a continuous vibration starts to be outputted relative to the media data. When the media data is outputted to the vibration start time stamp, the continuous vibration may start to be outputted. For example, the media data is audio data. A continuous vibration needs to be started when audio is played to the 10^{th} second, and then the 10^{th} second of the audio is a vibration start time stamp. At this moment, a start time stamp of the continuous vibration may be a start time stamp relative to the self vibration, i.e. the 0^{th} second, or may be a time stamp of starting vibration relative to the audio, i.e. the 10^{th} second. In this embodiment of the present disclosure, the vibration start time stamp may be recorded as T0. Play of the media (for example, audio) and the vibration may start at the same time at the vibration start time stamp T0, to determine synchronous start.

The alignment processing refers to a process of establishing a correspondence between a vibration time stamp recorded in the vibration file and a play time stamp in the media data. A vibration time stamp recorded in the aligned vibration file corresponds to a play time stamp in the media data. Each vibration time stamp in the vibration file corresponds to a play time stamp in the media data. Schematically, after the audio is aligned with the vibration file, the 10^{th} second of the audio corresponds to the 0^{th} second recorded by the vibration file, the 11^{th} second of the audio corresponds to the 1^{st} second recorded by the vibration file, the 12^{th} second of the audio corresponds to the 2^{nd} second recorded by the vibration file, . . . , and so on, until the time corresponds to the end time stamp recorded by the vibration file.

Through the alignment processing, the correspondence between the play time stamp of the media data and the vibration time stamp of the vibration can be established, thereby facilitating subsequent determining of the synchronization time stamp. In addition, through the alignment processing, output of the media data and the vibration may be started at the same time at the vibration starting time stamp, to ensure that starting of the media data and the vibration are synchronous. Further, synchronous playing of the media data and the vibration at corresponding time stamps may be implemented again based on the determined synchronization time stamp.

Operation 2.2: Perform Synchronization Point Identification Processing on the Media Data, to Determine a Synchronization Reference Time Stamp from the Media Data.
Operation 2.3: Determine, Based on a Correspondence Between Play Time Stamps and Vibration Time Stamps, a Vibration Time Stamp Corresponding to the Synchronization Reference Time Stamp from the Vibration File, and Use the Determined Vibration Time Stamp as the Synchronization Time Stamp Determined from the Vibration File.

The determined synchronization reference time stamp may include one or more play time stamps in the media data. After a synchronization reference time stamp is determined, based on the correspondence between the vibration time stamp and the play time stamp, a vibration time stamp corresponding to the synchronization reference time stamp may be determined from the vibration time stamps recorded in the vibration file, and is used as the synchronization time stamp. The determined synchronization time stamp may include one or more vibration time stamps recorded in the vibration file. For example, the media data is audio data of 10 seconds(s) (0^{th} s to 10^{th} s), the vibration file records a vibration of 2 s (0^{th} s to 2^{nd} s), and a time stamp that the vibration starts to be outputted relative to the audio is the 4^{th} s of the audio. If the determined synchronization reference time stamp includes the 5^{th} s and the 5.5^{th} s of the audio, based on the correspondence between the play time stamp and the vibration time stamp, the synchronization time stamp includes the 1^{st} s and the 1.5^{th} s of the vibration. In another mode, the synchronization time stamp may alternatively include the 5^{th} s and the 5.5^{th} s of the audio.

In the foregoing mode of determining the synchronization time stamp, by aligning the media data and the vibration file, a correspondence therebetween in the time stamp may be established, and after synchronization point identification processing is performed on the media data, the synchronization time stamp may be determined based on the established correspondence. In this way, the synchronization time stamp is determined from the media data, so that a more proper synchronization time stamp can be determined according to different features of the media data to some extent, thereby ensuring a synchronization effect.

Logic of synchronization point identification processing varies correspondingly based on different types of media data and different service scenes. The service scene may include but is not limited to: audio synchronization, video synchronization, game scene synchronization, and other synchronization (such as time synchronization). The following describes determining of the synchronization reference time stamp in each service scene in detail, as shown in the following (1) to (3).

### (1) Audio/Video Synchronization Scene.

The media data includes audio data or video data. The operation of performing synchronization point identification processing on the media data, to determine a synchronization reference time stamp from the media data includes content described in the following (1) to (2): (1) Determine reference media data corresponding to the vibration file from the media data. (2) Obtain a data difference between two neighboring frames in the reference media data, and use a play time stamp corresponding to a previous frame in the two neighboring frames as one synchronization reference time stamp when the data difference reaches a difference threshold.

Specifically, reference media data corresponding to the vibration file may be first determined from the media data based on an alignment relationship between the media data and the vibration file. The reference media data may be a part of the media data, or may be the entire media data. For example, for a video from the 0^{th} s to the 15^{th} s, a continuous vibration is set in the 5^{th} s to the 6^{th} s of the video, and the reference media data is video data from the 5^{th} s to the 6^{th} s. A play duration of the reference media data is equal to a vibration duration corresponding to the vibration file, so as to indicate that a vibration with a duration exists in the process of playing the reference media data.

Then, a data difference between two frames may be obtained, and the synchronization reference time stamp is determined based on a relationship between the data difference and a difference threshold. A data difference between two neighboring frames in the reference media data is a data difference of a subsequent frame relative to a previous frame. The two neighboring frames include an i^{th} frame and an (i+1)^{th} frame that are neighboring, a time point of the i^{th} frame is earlier than a time point of the (i+1)^{th} frame, where i is a positive integer. The data difference between the two frames is a difference between an (i+1)^{th} frame of data and an i^{th} frame of data. When the data difference reaches the difference threshold, a play time stamp corresponding to the previous frame is used as a synchronization reference time stamp, so as to use a vibration time stamp corresponding to the synchronization reference time stamp as a synchronization time stamp. In this way, before a relatively large change is reached, synchronization between vibration and a media frame can be implemented, so that an object feels that audio/video and vibration are synchronously performed.

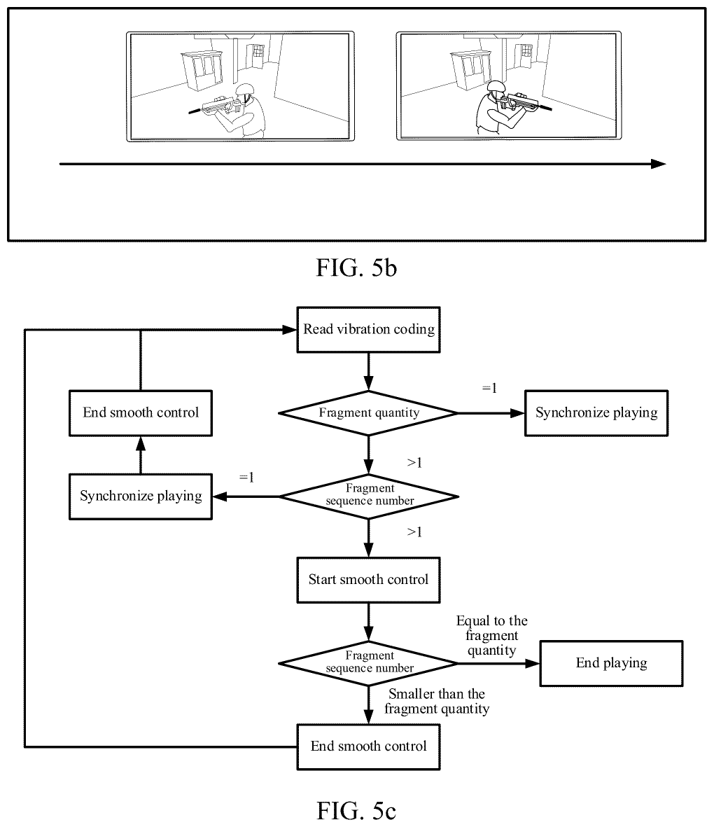

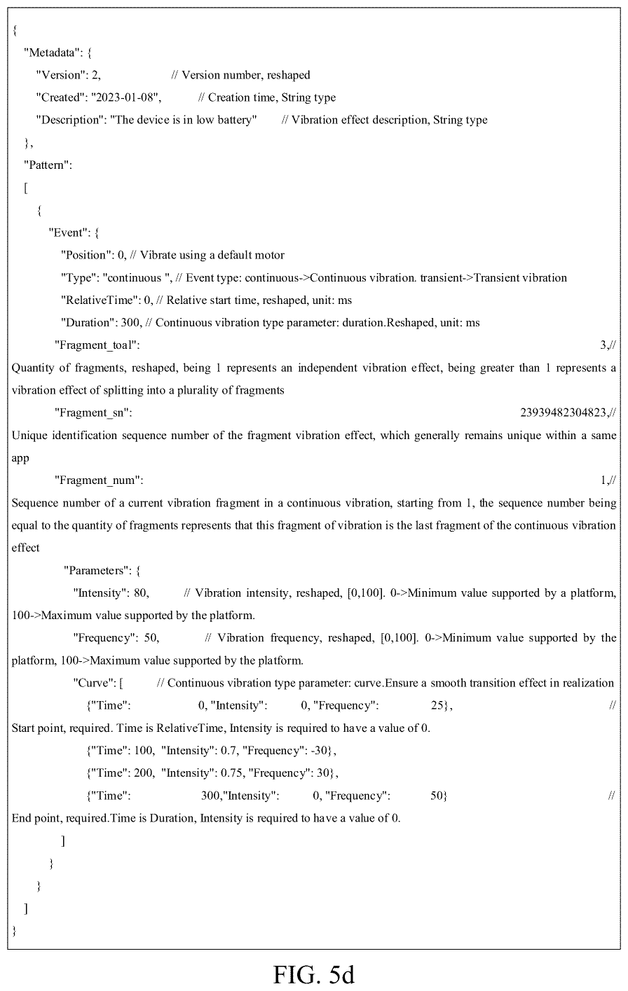

The data difference reaching the difference threshold may mean that the data difference is greater than the difference threshold, to indicate that the (i+1)^{th} frame is greatly changed relative to the i^{th} frame. The data difference and the difference threshold are different according to different types of media data. If the media data includes the audio data, the data difference reaching the difference threshold means that: an audio difference between two neighboring frames reaches a first difference threshold. The audio difference may be an audio energy difference, or may be an audio power difference. Correspondingly, the first difference threshold may be an energy difference threshold or a power difference threshold. This is not limited in the present disclosure. In this mode, the determined synchronization reference time stamp is a time stamp at which the object senses the audio relatively weakly. A vibration time stamp corresponding to the synchronization reference time stamp is used as the synchronization time stamp, and audio play and vibration play may be synchronized again when the synchronization time stamp reaches, so that synchronization is performed in advance before an upcoming audio peak value. After the synchronization time stamp, the object feels that the audio and the vibration are synchronously performed without an excessively large deviation. Selection of other synchronization time stamps is also similar, so as to ensure that the audio and the vibration are synchronized before the audio peak value reaches, thereby reducing the deviation as much as possible. Because the synchronization time stamp is subsequently configured for dividing the vibration file, the synchronization time stamp may alternatively be referred to as a vibration division point or a vibration division node. Schematically, refer to a schematic diagram of determining a synchronization time stamp in an audio synchronization scene shown in FIG. 5a. The synchronization time stamps (including T1, T2, and T3) are time stamps before the audio peak value reaches, and these time stamps may alternatively be considered as change points of the audio. Playing of the vibration and playing of the audio are synchronized between the change points, so that the object can sense synchronization of the audio and the vibration, thereby providing better playing experience.

If the media data includes the video data, the data difference reaching the difference threshold means that: a picture difference between two neighboring frames reaches a second difference threshold. Identification of a synchronization point by using a video as a reference means that the synchronization reference time stamp is set before a relatively large change occurs in a video picture. The data difference is the picture difference, and the difference threshold is the second difference threshold. The picture difference reaching the second difference threshold indicates that a picture in a subsequent frame is greatly changed relative to a picture in a previous frame. Because a vibration sense set at a time point of a relatively large change is relatively strong, time stamp synchronization is performed in advance before a relatively large change occurs in a picture, so that the object can feel that the vibration and the picture are synchronously performed, and the picture change has higher conformity to the vibration, thereby providing better watching experience. For example, if the synchronization reference time stamp is set at the 50^{th} millisecond (ms) of the video, synchronization of playing the vibration file aligned with the video may be performed again at the synchronization time stamp at the vibration time stamp corresponding to the 50^{th} ms, thereby ensuring overall synchronous output.

### (2) Game Scene Synchronization.

The media data includes game data. The game data includes one or more skill operation data in a game. The operation of performing synchronization point identification processing on the media data, to determine a synchronization reference time stamp from the media data includes content described in the following (1) to (2): (1) Obtain operation time stamps corresponding to the skill operation data in the game data. (2) Use, when any skill operation data corresponds to at least two operation time stamps, the at least two operation time stamps corresponding to any skill operation data as synchronization reference time stamps.

In a game synchronization scene, triggering of a vibration is related to a game scene. For example, controlling a virtual character in a game to release a skill may be accompanied with sound effect play, picture change, and vibration. In the game scene, synchronization of audio, pictures, and vibrations can bring better game control experience.

Any skill operation data may be configured for describing a skill operation triggered at a corresponding time stamp. Skill operations described by different skill operation data are different. One or more operation time stamps corresponding to any skill operation data may be included. For example, in an arena game, an operation of replacing equipment by a virtual character may be subdivided into an operation c1 and an operation c2. A time stamp at which the virtual character starts to perform the operation c1 may be used as one operation time stamp, and a time stamp at which the virtual character starts to perform the operation c2 may be used as another operation time stamp. When any skill operation data includes at least two operation time stamps, the at least two operation time stamps may be used as synchronization reference time stamps. Further, a synchronization time stamp may be determined from the vibration file according to the synchronization reference time stamp, so as to split the vibration file corresponding to the skill operation into vibration fragments corresponding to different operations, thereby synchronizing vibration and operation changes according to the vibration fragments, to synchronize audio, pictures, and vibrations corresponding to the skill operation, improve tactile, auditory, and visual sense consistency in a game scene, create a better game atmosphere, and improve control experience. Schematically, as shown in FIG. 5b for synchronization in a game scene, when a game picture changes, for example, a virtual character performs different operations, operation time stamps T1 and T2 of triggering the operations may be determined as synchronization time stamps. After the operations are performed at T2, an orientation of the virtual character also changes correspondingly. Further, the vibration file is split into two fragments according to the synchronization time stamps, and the vibration file is synchronized with the change in the game scene at the two synchronization time stamps.

If any skill operation data corresponds to one operation time stamp, the operation time stamp may be a triggering time stamp for correspondingly triggering the vibration. Output of a corresponding vibration may be directly and synchronously started in the triggering time stamp, and audio and/or video corresponding to an operation skill may alternatively be synchronously started, to implement consistency in multidimensional sensing.

### (3) Other Scenes.

In an implementation, synchronization point identification processing for the media data may be implemented based on a fixed duration. The operation of performing synchronization point identification processing on the media data, to determine a synchronization reference time stamp from the media data includes content described in the following (1) to (2): (1) Obtain a reference duration. (2) Perform synchronization point identification processing on the media data according to the reference duration, to obtain the corresponding synchronization reference time stamp.

The reference duration is a fixed duration, for example, 200 milliseconds (ms). In a feasible mode, the reference duration may be set according to a frame length of an audio frame/a video frame. Schematically, if a frame length of an audio frame is 100 ms, the reference duration may be set to a multiple of the frame length of the audio frame, for example, 300 ms. By setting a multiple of a frame length, the vibration can be made to be as close to output of different frames as possible, so that the vibration is synchronized with the media frame, and a vibration effect conforms to a change of the media frame, thereby achieving a better synchronization effect and bringing better experience. In another feasible mode, the reference duration may alternatively be randomly set, for example, may be randomly set to 150 ms.

The reference duration may be used as a vibration duration of the vibration fragment, and a vibration within the reference duration is a vibration with a relatively short duration. In this way, a synchronization deviation between the vibration and the media (for example, audio/video) can be reduced as much as possible. The operation of performing synchronization node identification processing on the media data according to the reference duration may be determining a synchronization reference time stamp at an interval of the reference duration. For example, the reference duration is 500 milliseconds (ms), and for an audio of 2 seconds(s), a synchronization reference time stamp may be set at an interval of 500 ms, so that three synchronization reference time stamps may be obtained, namely the 500^{th} ms, the 1^{st} ms, and the 150^{th} ms.

In an implementable mode, synchronization point identification performed based on the reference duration may further be combined with a scene such as audio/video/game synchronization. Schematically, when the duration between the synchronization reference time stamps determined in these service scenes (1) and (2) is greater than the duration threshold, a new synchronization reference time stamp may be determined between the synchronization reference time stamps according to the reference duration. The duration threshold mentioned above is a threshold value at which an object can sense asynchronization between the vibration and the media. A larger duration exceeding the duration threshold and between synchronization reference time stamps indicates that the object can sense the asynchronization between the vibration and the media more clearly. The reference duration is further split to obtain a new synchronization reference time stamp, so that the duration between the synchronization reference time stamps may be shortened, more synchronization reference time stamps are added, and the vibration file may be split in finer details. Based on synchronization between the fragmented vibration and the media fragments, a synchronization effect can be further improved.

In the foregoing synchronization service scenes, time stamps recorded by the media data and the vibration file may be aligned when corresponding synchronization time stamps are reached, to synchronize the fragmented vibration and the media fragments, thereby ensuring synchronous output of the vibration and the media.

### Operation 3: Split the Vibration File According to the Synchronization Time Stamps, to Obtain a Plurality of Vibration Fragments of the Vibration File.

If a synchronization time stamp is determined, the vibration file may be split into two vibration fragments according to the synchronization time stamp. If a plurality of synchronization time stamps are determined, the vibration file may be split into two or more vibration fragments according to the synchronization time stamps. Schematically, in a game scene, the determined synchronization time stamp includes two operation time stamps, the vibration file may be split into two vibration fragments based on the two synchronization time stamps, and a vibration outputted by each vibration fragment corresponds to one operation skill. Subsequently, the vibration and the change of the game scene may be synchronized at the synchronization time stamp, thereby bringing better game experience. Vibration durations corresponding to the vibration fragments obtained by splitting may be equal or unequal. Schematically, vibration durations corresponding to the three vibration fragments are respectively 100 milliseconds (ms), 200 ms, and 200 ms. In an implementable mode, the synchronization time stamp is determined by performing synchronizing node identification on the media data based on the reference duration. After the vibration file is split by using the synchronization time stamp, during actual play, vibrations and media may be synchronized at equal time stamps. The durations of the vibrations outputted by the vibration fragments are equal.

In conclusion, based on the mode of obtaining a plurality of vibration fragments of a vibration file described in operations 1 to 3, the synchronization time stamp of the vibration file may be determined from the media data, and the vibration file is split based on each synchronization time stamp. By splitting the vibration file, the continuous vibration recorded in the vibration file can be split into a continuous vibration with a shorter duration, thereby implementing fragmentation of the continuous vibration. Based on an effect that vibrations of the plurality of vibration fragments are fragmented vibrations, synchronization between the corresponding vibrations of the vibration fragments and corresponding media fragments is maintained at these synchronization time stamps, so that corresponding synchronization between overall vibration and media (for example, audio/video) can be achieved.

After the vibration file of the media data is obtained, in a feasible implementation, the vibration file may be split according to the content described in operations 1.2 and 1.3, to obtain a plurality of vibration fragments. In another feasible implementation, whether to perform operations 2 and 3, namely whether to split the vibration file may be determined according to a type of the continuous vibration recorded in the vibration file, which includes content described in the following (1) to (3).
(1) Determine a type of the continuous vibration recorded in the vibration file.

A type of the continuous vibration may include a first type and a second type according to the magnitude of a vibration duration of the continuous vibration. The first type of continuous vibration is a continuous vibration corresponding to a vibration duration greater than or equal to a preset threshold. The second type of continuous vibration is a continuous vibration corresponding to a vibration duration less than the preset threshold. For example, the preset threshold is 200 milliseconds (ms). If the vibration duration of the continuous vibration is 400 ms, the type of the continuous vibration is a first type, and the continuous vibration may be considered as a vibration having a relatively long duration. The first type of continuous vibration may be referred to as a continuous vibration for short. If the vibration duration of the continuous vibration is 100 ms, the type of the continuous vibration is a second type, the continuous vibration may be considered as a vibration having a relatively short duration. The second type of continuous vibration may be referred to as a transient vibration for short.

In other words, the type of the continuous vibration recorded in the vibration file of the media data may be determined based on the vibration duration of the continuous vibration: If the vibration duration of the continuous vibration is greater than or equal to the preset threshold, it may be determined that the vibration type of the continuous vibration is the first type. If the vibration duration of the continuous vibration is less than the preset threshold, it may be determined that the vibration type of the continuous vibration is the second type.
(2) Split the vibration file if the type of the continuous vibration is a first type, so that the vibration file includes a plurality of vibration fragments.

Specifically, if the type of the continuous vibration is the first type, it indicates that the vibration duration of the continuous vibration is greater than or equal to the preset threshold. The continuous vibration is a vibration having a relatively long duration. To ensure that output of the continuous vibration and output of the media data are synchronized as much as possible at each time point, and to reduce sensing of asynchronous output between the vibration and the media (for example, audio/video) by an object, the vibration file may be split, so as to split the continuous vibration into vibration fragments with a shorter duration. Each vibration fragment and a corresponding media fragment are started to be played at the vibration start time stamp, so that synchronization between the continuous vibration and the media (for example, audio/video) can be ensured as much as possible. A more detailed splitting of the vibration file indicates a larger quantity of vibration fragments included in the vibration file, and a better effect of synchronous output between the continuous vibration and the media (for example, audio/video). For splitting of the vibration file, refer to content described in operations 2 to 3, and details are not described herein again.
(3) If the type of the continuous vibration is a second type, the vibration file includes one vibration fragment. When the vibration file includes one vibration fragment, the coded information includes a triggering time stamp for triggering to output the continuous vibration.

Specifically, if the type of the continuous vibration is the second type, it indicates that the vibration duration of the continuous vibration is greater than or equal to the preset threshold. The continuous vibration is a vibration having a relatively short duration. Because the duration of the vibration is relatively short, the object senses asynchronization between the vibration and the media data relatively weakly. Therefore, the vibration file may not be split. The vibration file includes a vibration fragment. A vibration corresponding to the vibration fragment is a continuous vibration. In this case, the vibration fragment included in the vibration file may be directly coded, to obtain coded information of the vibration fragment. The coded information includes a triggering time stamp for triggering to output the continuous vibration. The vibration may be outputted at the same time when the media data is played to the triggering time stamp. For example, the media data is audio data of 2 s (0^{th} s to 2^{nd} s), and there is a continuous vibration corresponding to the 1.2^{nd} s to the 1.3^{rd} s of the audio. The triggering time stamp may be set to the 1.2^{nd} s, and the continuous vibration may be outputted at the same time when the audio is played to the 1.2^{nd} s. In a process of outputting the vibration, the audio of the 1.2^{nd} s to the 1.3^{rd} s is also outputted, so as to implement synchronization between the vibration and the audio.

Based on that the mode of processing the vibration file is determined according to the type of the continuous vibration described in the foregoing (1) to (3), the vibration file may be selected to be split or not to be split for the type of the continuous vibration, so that a vibration having a relatively long vibration duration can be processed by integrating more resources. In a case that a plurality of vibration files are processed simultaneously, the vibration files are correspondingly processed based on different types of continuous vibrations, so that processing efficiency can be improved, and a synchronous effect between vibrations and media can be ensured.

In an entire processing procedure, processing on the vibration may include a vibration effect editing stage, a vibration effect coding stage, and a vibration effect output stage. A synchronization time stamp obtained by performing synchronization node identification on media data (for example, audio and video data) may be obtained at the vibration effect editing stage, and then the vibration file is split based on the synchronization time stamp, to implement fragmentation of the continuous vibration. The vibration file including the fragmented continuous vibration may be coded at the vibration effect coding stage, to obtain coded information of each vibration fragment. The output control of the vibration may be performed according to the coded information at the vibration effect output stage, to implement continuity of the vibration output and synchronization with the media output.

In one embodiment, the coded information of the current vibration fragment includes a fragment quantity field (Fragment_toal). The fragment quantity field is configured for indicating a total quantity of fragments corresponding to the one or more vibration fragments included in the vibration file. A value of the fragment quantity field is equal to a total quantity of vibration fragments included in the vibration file. For example, if the value of the fragment quantity field is K, the vibration file includes K vibration fragments, where K is a positive integer.

Whether the vibration file is split and a vibration effect of continuous vibration recorded by the vibration file may be indicated based on different values. When the value of the fragment quantity field is greater than 1, the vibration file is split into a plurality of vibration fragments. The continuous vibration corresponds to a fragmented vibration effect of splitting into a plurality of fragments for vibration. For example, when the value of the fragment quantity field is 2, it indicates that the vibration file is split into two vibration fragments, and the continuous vibration corresponds to the fragmented vibration effect. When the value of the fragment quantity field is equal to 1, the vibration file is not split. The continuous vibration corresponds to an independent vibration effect. To be specific, the vibration is started at a corresponding triggering time stamp, and the vibration is ended when the duration is reached.

In one embodiment, the one or more vibration fragments included in the vibration file are arranged in sequence, and a vibration corresponding to any vibration fragment is outputted according to a corresponding sequence. The coded information of the current vibration fragment includes a fragment sequence number field (Fragment_num). The fragment sequence number field is configured for indicating a sequence number of the current vibration fragment in the vibration file. The sequence number is configured for indicating an output sequence of a corresponding vibration of the current vibration fragment. The sequence number of the current vibration fragment in the vibration file may be an integer starting from 1, or may be another character string. For example, when a value of the fragment sequence number field of the current vibration fragment is 1, it indicates that the current vibration fragment is the first vibration fragment in the vibration file. In the process of outputting the continuous vibration, a vibration corresponding to the vibration fragment is first outputted. The output sequence may indicate a position of the current vibration fragment in the vibration file.

In a feasible implementation, values of the fragment sequence number field (Fragment_num) and the fragment quantity field (Fragment_toal) are both reshaped data. If a value of the fragment sequence number field of the current vibration fragment is equal to a value of the fragment quantity field of the current vibration fragment, the current vibration fragment is the last vibration fragment in the one or more vibration fragments arranged in sequence. For example, if the value of Fragment_toal of the current vibration fragment is 3 and the value of Fragment_num of the current vibration fragment is also 3, it indicates that the current vibration fragment is the last vibration fragment in the vibration fragments arranged in sequence in the vibration file and a vibration corresponding to the current vibration fragment is the last vibration fragment in the continuous vibration. The position of the current vibration fragment in the vibration file may be separately indicated by using the fragment sequence number field, or the position can be more accurately indicated in combination with a fragment total field. The vibration corresponding to the current vibration fragment may be outputted based on the position of the current vibration fragment and other parameters recorded in the coded information.

As a feasible implementation, the coded information of the current vibration fragment includes a fragment identification field (Fragment_sn). The fragment identification field is configured for indicating an identification sequence number of the current vibration fragment. The identification sequence number may be a digit or a string of characters, has uniqueness, and may be configured for indicating that the continuous vibration recorded in the vibration file has a fragmented vibration effect. Schematically, a value of Fragment_sn is 23939482304823, and an identification sequence number of the current vibration fragment is “23939482304823”. The identification sequence number is associated with an application corresponding to the media data, and one application corresponds to one identification sequence number. The application corresponding to the media data is an application providing the media data, and the application includes but is not limited to: an audio application, a video application, a game application, a livestreaming application, or the like. This is not limited in the present disclosure. The identification sequence number remains unique in a same application. For different vibration fragments included in the vibration file, a same identification sequence number may be used in the application corresponding to the media data. The value of the fragment identification field may facilitate distinguishing a vibration effect of a corresponding vibration of media data of different applications, to provide a further indication for a fragmented vibration effect.

In one embodiment, the coded information of the current vibration fragment includes the following one or more fields: a fragment quantity field, a fragment sequence number field, and a fragment identification field. The position of the current vibration fragment in the vibration file may be identified by using the foregoing fields. Schematically, the following content may be identified by using the fragment quantity field, the fragment sequence number field, and the fragment identification field: the position of the current vibration fragment in the vibration file, and the vibration file being split into a plurality of vibration fragments. In addition to the foregoing fields, the coded information includes a relative start time field (RelativeTime). The relative start time field is configured for recording a vibration start time stamp of the current vibration fragment relative to the corresponding media fragment. The vibration start time stamp may be a time stamp at which the vibration corresponding to the current vibration fragment is triggered to be outputted. The media fragments start to be outputted when the media data is played to the vibration start time stamp. A value of the vibration start time stamp is reshaped data in milliseconds (ms). For example, the media data indicates an audio of 20 s (a play start time point of the audio is the 0^{th} s, and a play end time point of the audio is the 20^{th} s), and the audio corresponds to a continuous vibration (0-5 s) from the 10^{th} s to the 15^{th} s. An audio fragment corresponding to the current vibration fragment is a fragment from the 10^{th} s to the 11^{th} s of the audio. Therefore, the vibration start time stamp of the current vibration fragment relative to the media fragment may be the 10^{th} s of the audio, i.e. the 0^{th} s of the continuous vibration. Based on a record of the relative start time field, starting to vibrate based on the current vibration fragment may be controlled, to synchronize starting of the vibration fragment and starting of the media fragment.

S402: Output, according to a play duration of the media fragment and a vibration parameter recorded in the coded information of the current vibration fragment, a current vibration equal to the play duration when the media fragment corresponding to the current vibration fragment is played to the vibration start time stamp.

When the media fragment corresponding to the current vibration fragment is played to the vibration start time stamp, vibration synchronization corresponding to the media fragment may be triggered to start to be outputted. Therefore, the vibration corresponding to the current vibration fragment may be controlled to be outputted. Specifically, a related field in the coded information of the current vibration fragment may be parsed, and a vibration is outputted according to content indicated by the value of the field.

The vibration parameter recorded in the coded information may include one or more of the following (1) to (6).
(1) A position field (Position) is configured for indicating an output mode of a vibration. If a value of the position field is a first preset value (for example, “0”), it indicates that a default motor vibration is used. In addition to the motor vibration, the vibration may alternatively be based on other hardware, for example, an electric motor vibration.
(2) An event type field (Type) is configured for indicating an event type. If a value of the event type field is a first preset value (for example, “continuous”), it indicates that the current vibration fragment corresponds to a continuous vibration. If the value of the event type field is a second preset value (for example, “transient”), it indicates that the current vibration fragment corresponds to a transient vibration.
(3) A duration field (Duration) may be configured for indicating a duration of a vibration of the current vibration fragment (or referred to as a vibration duration). The duration may be equal to a play duration of a corresponding media fragment. This field belongs to a continuous vibration type parameter, and has a value of shaped data in milliseconds (ms). For example, the value of Duration being 200 ms indicates that the duration of the vibration is 200 ms.
(4) A vibration intensity field (Intensity) is configured for indicating a vibration intensity of the current vibration fragment. A value range is [0, 100]. 0 is a minimum value supported by a platform, and 100 is a maximum value supported by the platform.
(5) A vibration frequency (Frequency) has a value range of [0, 100]. 0 is a minimum value supported by a platform, and 100 is a maximum value supported by the platform.
(6) A curve field (Curve) belongs to a continuous vibration type parameter, and a smooth transition effect may be ensured based on the curve field during a vibration implementation. The Curve may include the following settings: a vibration intensity and a vibration frequency at a start point, a vibration intensity and a vibration frequency at an end point, and a vibration intensity and a vibration frequency at an intermediate point. A value of the start point is the same as the value of the RelativeTime, and the end time point may be determined based on the Duration and the RelativeTime. For example, in {“Time”: 0, “Intensity”: 0, “Frequency”: 25}, Time is the start point. A value of Time is the value of RelativeTime, and a value of Intensity is 0 to ensure that the vibration maintains the originally set vibration intensity at the vibration start time stamp. In {“Time”: 200, “Intensity”: 0, “Frequency”: 50}, Time is the end point. A value of Time is the value of Duration, and the value of Intensity is 0 to maintain the vibration intensity at the vibration end time stamp, so that an effect of affecting a next fragment of vibration can be avoided.

A field, a vibration parameter, and the like included in the coded information are parsed, and the vibration may be performed according to the information obtained by parsing. By starting the vibration and outputting the media fragment at the vibration start time stamp, it can be ensured that the current vibration and the output of the media fragment start at the same time. The duration of the vibration that is kept being outputted is equal to the play duration, so that it can be effectively ensured that the current vibration and the output of the media data end at the same time, and discontinuity between fragmented vibrations caused because the actual vibration ends too early or too late is avoided, thereby avoiding vibration freeze or interruption, and ensuring continuity and smoothness of the continuous vibration.

In one embodiment, the current vibration outputted based on the current vibration fragment includes a vibration start stage, a vibration-in-process, and a vibration end stage. A vibration corresponding to any vibration fragment in the vibration file includes the foregoing stages. The current vibration fragment correspondingly vibrates to any of the foregoing stages, and may correspond to different processing modes, including content shown in the following (1) to (3).
(1) The vibration start stage of the current vibration fragment is configured for: starting to synchronize the outputted current vibration with the media fragment.

At the vibration start stage, the outputted current vibration and the media fragment may start to be synchronized. Specifically, this may be implemented based on the vibration start time stamp indicated by the relative start time field in the coded information of the current vibration fragment. To be specific, the current vibration and the media fragment are synchronously triggered to be outputted at the corresponding vibration start time stamp.
(2) The vibration-in-process of the current vibration fragment is configured for: performing vibration output according to the vibration parameter recorded in the coded information of the current vibration fragment.

During the vibration, the vibration output may be performed according to an indication of the vibration parameter, such as the vibration intensity field, the vibration frequency field, or the curve field, included in the coded information.
(3) The vibration end stage of the current vibration fragment is configured for: making the outputted current vibration equal to the play duration.

To make the outputted vibration duration of the current vibration equal to the play duration of the corresponding media fragment, a vibration end time stamp of the current vibration may correspond to the play end time stamp, so that the current vibration and the playing of the media fragment are synchronously ended. The vibration end time stamp is an actual end time stamp at which the current vibration is outputted. Because the vibration is performed depending on a hardware device, the vibration may be ended too early or completely. When the play end time stamp of the media fragment is reached, output of the current vibration is ended or the current vibration is continued until the play end time stamp, which can ensure that the current vibration having a same length as the play duration is outputted, thereby achieving a good synchronization effect.

In one embodiment, the position of the current vibration fragment in the vibration file includes any one of the following: a vibration start section, a vibration intermediate section, and a vibration end section. The plurality of vibration fragments in the vibration file may be arranged in sequence. The vibration start section is a first vibration fragment in the plurality of vibration fragments arranged in sequence in the vibration file. The vibration intermediate section is a non-first or non-last vibration fragment in the plurality of vibration fragments arranged in sequence in the vibration file. When the current vibration fragment is the vibration intermediate section, the vibration file includes at least three vibration fragments. The at least three vibration fragments are three or more vibration fragments. To be specific, when the vibration file includes three or more vibration fragments, the vibration intermediate section exists. If the current vibration fragment is the vibration intermediate section, after the vibration corresponding to the current vibration fragment, a vibration corresponding to a vibration fragment that is not outputted still exists, and a vibration corresponding to a vibration fragment before the current vibration fragment is outputted. The vibration end section is the last vibration fragment in the plurality of vibration fragments arranged in sequence in the vibration file. When the vibration file includes two vibration fragments, the current vibration fragment may be a vibration start section or a vibration intermediate section. Schematically, if the continuous vibration corresponding to the vibration file is fragmented into two fragments of vibration, the vibration file includes two vibration fragments, the first vibration fragment is the vibration start section, and the second vibration fragment is the vibration end section.

For any vibration fragment in the vibration file, the correspondingly outputted vibration may include a vibration start stage, a vibration-in-process, and a vibration end stage. When the current vibration fragment is at the vibration start stage and the vibration end stage, a corresponding policy may be used for ensuring continuity of the vibration based on the position of the current vibration fragment in the vibration file. The vibration may be performed according to a corresponding vibration parameter (such as a vibration intensity, a vibration frequency, and a vibration duration) in the process of outputting the vibration.

As an implementable mode, when the current vibration fragment is at the vibration start stage and the current vibration fragment is the vibration intermediate section or the vibration end section, it indicates that the current vibration fragment is a non-first vibration fragment in the plurality of vibration fragments arranged in sequence in the vibration file, and a vibration corresponding to a vibration fragment that has been outputted exists before the current vibration fragment. To ensure continuity between vibrations corresponding to neighboring vibration fragments, content shown in the following (1) to (2) may further be included.
(1) Obtain a vibration end state corresponding to a previous vibration fragment of the current vibration fragment.

The previous vibration fragment is a vibration fragment that is outputted before the current vibration fragment. The vibration end state is configured for indicating: whether a vibration corresponding to the previous vibration fragment ends normally. In an implementation, whether a vibration corresponding to a previous vibration fragment ends normally may be determined based on whether a vibration end time stamp of the previous vibration fragment reaches a play end time stamp of a media fragment corresponding to the previous vibration fragment on time. If the vibration end time stamp of the previous vibration fragment is earlier than or later than the play end time stamp of the media fragment corresponding to the previous vibration fragment, it may indicate that the vibration corresponding to the previous vibration fragment does not end normally. If the vibration end time stamp of the previous vibration fragment is the same as the play end time stamp of the media fragment corresponding to the previous vibration fragment, it indicates that the vibration corresponding to the previous vibration fragment ends normally. In another implementation, whether the vibration corresponding to the previous vibration fragment ends normally may be determined based on whether a vibration state (for example, a vibration intensity or a vibration frequency) of the vibration is normal. For example, if the vibration intensity is greater than the preset intensity threshold when the play end time stamp of the media fragment corresponding to the previous vibration fragment is reached, it indicates that the vibration corresponding to the previous vibration fragment ends abnormally. In this embodiment of the present disclosure, the vibration corresponding to the previous vibration fragment may alternatively be referred to as a pre-vibration, and the vibration corresponding to the current vibration fragment may alternatively be referred to as a current vibration.

Whether to perform smooth vibration processing on the vibration parameter of the previous vibration fragment may be determined according to an indication of a vibration end state of the previous vibration fragment. The content is described in the following (2):
(2) Perform smooth vibration processing based on a vibration parameter of the previous vibration fragment if the vibration end state indicates that the vibration corresponding to the previous vibration fragment ends abnormally, and after smooth vibration is completed, control to output the vibration corresponding to the current vibration fragment when the media fragment corresponding to the current vibration fragment is played to the vibration start time stamp.

In an implementable mode, if the vibration end time stamp of the previous vibration fragment is earlier than or later than the play time stamp of the media fragment corresponding to the previous vibration fragment, the vibration end state of the previous vibration fragment may indicate that vibration of the previous vibration fragment abnormally ends. Because abnormal ending of the previous vibration fragment may cause discontinuity between vibrations, to maintain smoothness between vibrations, smooth vibration processing may be performed based on a vibration parameter (for example, a vibration intensity field, a vibration frequency field, or a curve field) of the previous vibration fragment. Specifically, a current hardware state (for example, a vibration state of the previous vibration fragment at the vibration end time stamp) may smoothly transition to a target hardware state (i.e. a vibration state of the current vibration fragment at the vibration start time stamp), to ensure that vibration experience felt by an object is continuous and smooth. The smooth vibration processing may be performed based on the curve field recorded in the coded information. The vibration intensity and the vibration frequency are changed within the corresponding duration according to the curve field, thereby ensuring a smoother change of the vibration intensity and the vibration frequency within the duration of the vibration.

If the vibration end state of the previous vibration fragment indicates that the previous vibration fragment normally ends vibrating, the vibration may be normally performed according to the vibration start time stamp recorded in the coded information of the current vibration fragment.

According to the foregoing descriptions of (1) to (2), a processing mode between the two vibration fragments is determined based on whether the previous vibration fragment of the current vibration fragment ends normally, and smooth vibration processing is performed when the previous vibration fragment does not end normally, so as to achieve smoothness of connection between the two vibration fragments, ensure continuity of the vibration, and improve a synchronization effect and conformity between the vibration and media.

In another implementable mode, when the current vibration fragment is at the vibration end stage, the operation of outputting, according to a play duration of the media fragment and a vibration parameter recorded in the coded information of the current vibration fragment, a current vibration equal to the play duration includes the following cases shown in (3) to (5).
(3) Keep, if a vibration end time stamp of the current vibration fragment is earlier than a play end time stamp of the media fragment corresponding to the current vibration fragment, a vibration effect of the current vibration fragment at the vibration end time stamp until the play end time stamp is reached.

The vibration end time stamp of the current vibration fragment is an actual end time of the vibration outputted based on the current vibration fragment. Without any intervention, the vibration performed based on a hardware device (for example, motor hardware) may end too early or too late than the play end time stamp (which may be used as a preset end time stamp of the vibration). When the vibration time stamp of the current vibration fragment is earlier than the play time stamp of the media fragment corresponding to the current vibration fragment, it indicates that the vibration outputted based on the current vibration fragment ends ahead of time. Because the vibration outputted by the current vibration fragment ends earlier and a subsequent vibration fragment does not reach the vibration start time stamp, the vibration interruption occurs visually, leading to poor experience. Therefore, it is necessary to maintain continuity of work of the motor hardware and the subsequent vibration. As a feasible implementation, when the vibration ends ahead of time, the vibration effect of the current vibration fragment at the vibration end time stamp may be continuously kept until the play end time stamp of the media fragment is reached. For example, in a time period from the vibration time stamp to the play end time stamp, the vibration intensity and the vibration frequency of the vibration at the vibration end time stamp are kept unchanged. In this way, the vibration may be continued when the current vibration ends ahead of time, thereby avoiding an interruption phenomenon caused when the vibration ends ahead of time.

For vibration fragments at different positions in the vibration file, if the corresponding vibration ends earlier, continuity of the vibration may be ensured in the foregoing mode. However, if the vibration outputted based on the vibration fragment is not stopped when the play end time stamp is reached, the vibration output may be performed by using different processing policies based on different positions of the current vibration fragment, as shown in (4) and (5) below.
(4) Stop outputting, when the current vibration fragment is the vibration start section or the vibration intermediate section if the vibration end time stamp of the current vibration fragment is later than the play end time stamp of the media fragment corresponding to the current vibration fragment, the current vibration when the current vibration fragment reaches the play end time stamp, and output a vibration corresponding to a subsequent vibration fragment of the current vibration fragment.

When the current vibration fragment is the vibration start section or the vibration intermediate section, if the vibration end time stamp of the current vibration fragment is later than the play end time stamp of the media fragment corresponding to the current vibration fragment, it indicates that the current vibration fragment reaches a preset end time stamp of the vibration and does not end the vibration either. If the interference is not performed, an overall vibration delay is caused, a subsequent vibration is affected, and asynchronization between the vibration and the media data is sensed by an object. In a case that the vibration has not been completed when the play end time stamp is reached, output of the current vibration fragment may be stopped when the current vibration fragment reaches the play end time stamp. Then, a subsequent vibration fragment of the current vibration fragment is outputted, so as to directly start a next fragment of vibration. The subsequent vibration fragment is a vibration fragment sorted after the current vibration fragment in the vibration file.

When the vibration end time stamp of the current vibration fragment just reaches the play end time stamp of the corresponding media fragment, according to a vibration start time stamp of a subsequent vibration fragment of the current vibration fragment, the subsequent vibration fragment may be directly outputted, so as to output a next fragment of vibration.
(5) End the vibration if the vibration end time stamp of the current vibration fragment is later than the play end time stamp of the media fragment corresponding to the current vibration fragment when the current vibration fragment is the vibration end section.

When the current vibration fragment is the vibration end section, it indicates that the last fragment of vibration of the continuous vibration is outputted based on the current vibration fragment. The vibration is not ended before the current vibration fragment reaches the play end time stamp, and the vibration may be directly ended. So far, the continuous vibration recorded by the vibration file has been completed. It can be seen that, regardless of whether the vibration end time stamp of the current vibration fragment is earlier or later than the play end time stamp, the vibration end time stamp can be calibrated to the play end time stamp through the foregoing processing, and it is ensured that the subsequent vibration fragment starts to vibrate at the vibration start time stamp, so as to ensure synchronization between the corresponding vibration of the current vibration fragment and the playing of the media fragment.

In the foregoing mode, the continuous vibration is fragmented to be outputted based on the vibration fragments included in the vibration file, and it is ensured by the foregoing processing that each vibration fragment starts at the vibration start time stamp, and the vibration end time stamp of each vibration fragment is aligned with the play end time stamp of the media fragment, so that the vibration duration corresponding to each vibration fragment is equal to the play duration of the media fragment, thereby achieving an effect of synchronizing the vibration and the playing of the media data.

According to the vibration processing method provided in this embodiment of the present disclosure, a current vibration fragment and coded information of the current vibration fragment may be obtained from a vibration file of media data. The vibration file includes one or more vibration fragments, and one vibration fragment corresponds to a media fragment of the media data. It can be seen that there is a correspondence between vibration fragments in the vibration file and media fragments in the media data. The correspondence may ensure that the vibration fragments are conforming to the media fragments. The coded information of the current vibration fragment may be configured for identifying a position of the current vibration fragment in the vibration file, and output a current vibration having a same length as the media fragment according to the play duration of the media fragment and the vibration parameter in the coded information based on the vibration start time stamp recorded in the relative start time field in the coded information of the current vibration fragment. It can be seen that the current vibration and the media fragment may be controlled to synchronously start to be outputted and synchronously end to be outputted based on the coded information of the current vibration fragment, so as to implement output synchronization between the current vibration and the media fragment. When outputting the corresponding vibration of each vibration fragment, it can be ensured that the vibration fragment is equal to the play duration of the corresponding media fragment, so as to ensure that the vibration of each fragment is synchronized with the output of the media fragment, synchronize overall vibration with media, and provide more immersive experience.

For ease of understanding, for control logic of synchronous output of vibrations and media data described in this embodiment of the present disclosure, the following example may be provided for description with reference to the vibration synchronization control logic provided in FIG. 5c.

### 1: Read Vibration Coding First.

Herein, reading the vibration coding may mean obtaining coded information of a current vibration fragment. Related fields included in the coded information may be parsed by reading the coded information, which includes but is not limited to: a fragment quantity field, a fragment identification sequence number field, a fragment sequence number field, a relative start time field, a vibration duration field, a vibration intensity field, and the like. For example, the obtained coded information of the current vibration fragment is shown in FIG. 5d. The coded information is obtained by coding the current vibration fragment according to a vibration coding rule after the splitting. As shown in FIG. 5d, fields such as “Fragment_toal”, “Fragment_sn”, and “Fragment_num” may be configured for identifying a position of the current vibration fragment in a vibration file. By performing identification by using the foregoing fields, whether the vibration file is split and an output sequence of the current vibration fragment when the vibration file is split into a plurality of vibration fragments can be learned. According to information such as the position of the current vibration fragment in the vibration file and a vibration parameter included in a coding parameter, a corresponding policy can be configured for outputting a vibration corresponding to the current vibration fragment. The Curve may be configured for ensuring a smooth transition of vibrations between the current vibration fragment and another vibration fragment, and a vibration intensity and a vibration frequency may be smoothed based on settings included in the curve field. Curve fields of different vibration fragments may be set to be different, so that vibrations at different fragments have a corresponding smoothing effect.

Play control may be prepared based on parsing of the fields included in the coded information. To be specific, subsequent control on vibration output and media play may be performed based on content indicated by values of the parsed fields.

### 2: Control to Output a Current Vibration Based on the Coded Information.

Whether the vibration file includes one vibration fragment or a plurality of vibration fragments may be analyzed based on the coded information. This may be obtained based on the Fragment_toal. The Fragment_toal may indicate a total quantity of fragments of a vibration fragment, i.e. a quantity of continuously vibrating fragments. If the quantity of continuously vibrating fragments is 1, in a synchronous play process, the vibration may be controlled to be outputted according to a synchronization policy. To be specific, the vibration file includes an independent vibration fragment, and corresponds to an independent vibration. Such a vibration effect does not need to be consistent with a vibration effect of a pre-vibration, and no subsequent vibration exists. Therefore, the vibration may be started according to the triggering time stamp recorded in the coded information, and the vibration is ended when the play time stamp of the media fragment corresponding to the vibration fragment is reached, to ensure as much as possible that a vibration duration is consistent with the play duration of the media fragment corresponding to the vibration fragment. To be specific, relatively good vibration experience can be achieved. After the vibration ends, it is unnecessary to consider how to smoothly interface with a subsequent vibration effect to ensure vibration continuity.

If the quantity of continuously vibrating fragments is greater than 1, each vibration fragment has a fragment sequence number, which is indicated by the Fragment_sn. The fragment sequence number is a sequence number of the vibration fragment in the vibration file. For vibration fragments having different fragment sequence numbers, there are corresponding processing policies: (1) If the fragment sequence number indicates that the current vibration fragment is the first vibration fragment (i.e. the vibration start section) in the vibration file, the vibration may be started to be outputted when the corresponding media fragment is played to the vibration start time stamp, so that synchronization between the vibration and media (for example, video) starts to be played. Because the vibration file includes a plurality of vibration fragments and a subsequent vibration fragment further exists after the first vibration fragment, smooth vibration processing (which may alternatively be referred to as smooth control) needs to be performed at the vibration end stage of the first vibration fragment. To be specific, the vibration end time stamp is calibrated according to whether the vibration corresponding to the vibration fragment ends normally. Thus, it is ensured that the duration of the vibration is equal to the play duration of the media fragment. (2) If the fragment sequence number indicates that the current vibration fragment is an i^{th} vibration fragment in the vibration file, where i is a value greater than 1 and less than the total quantity of the fragments (i.e. vibration intermediate section), a previous vibration fragment may be continued to perform smooth transition on vibration (to be specific, smooth control is started), and the current vibration fragment further needs to calibrate a vibration end time stamp according to whether the vibration of the current vibration fragment normally ends (to be specific, smooth control is ended).

If the fragment sequence number indicates that the current vibration fragment is the last vibration fragment (i.e. vibration end section) in the vibration file, the previous vibration fragment may be continued to perform smooth transition of vibration. Because the vibration is the last fragment of vibration of the continuous vibration, smoothing processing does not need to be performed to calibrate the vibration end time stamp, and the vibration is directly ended when the vibration end time stamp is reached. As a feasible implementation, no matter whether the vibration end time stamp is earlier than or later than the play end time stamp, no attention is needed. As another feasible implementation, calibration may alternatively be performed in the foregoing mode when the vibration end time stamp is earlier than or later than the play end time stamp, so that the current vibration is synchronized with ending of the media fragment.

After the current vibration is outputted based on the coded information of the current vibration fragment, coded information of a next vibration fragment may continue to be read, and the foregoing process is repeated to perform vibration output until coded information of all vibration fragments in the vibration file is completely read.

It can be seen that in the vibration processing scheme of the foregoing example, the current vibration may be controlled to be outputted based on obtaining the coded information of the current vibration fragment. Moreover, when the current vibration is outputted, the media fragment corresponding to the current vibration fragment may be outputted, so that the current vibration and the corresponding media fragment are synchronously outputted, thereby ensuring a synchronous effect of vibration output and media play. If there are a plurality of vibration fragments, in the process of outputting the current vibration, corresponding smoothing processing may further be performed based on a position of the current vibration fragment in the vibration file, to ensure continuity and smoothness of the vibration.

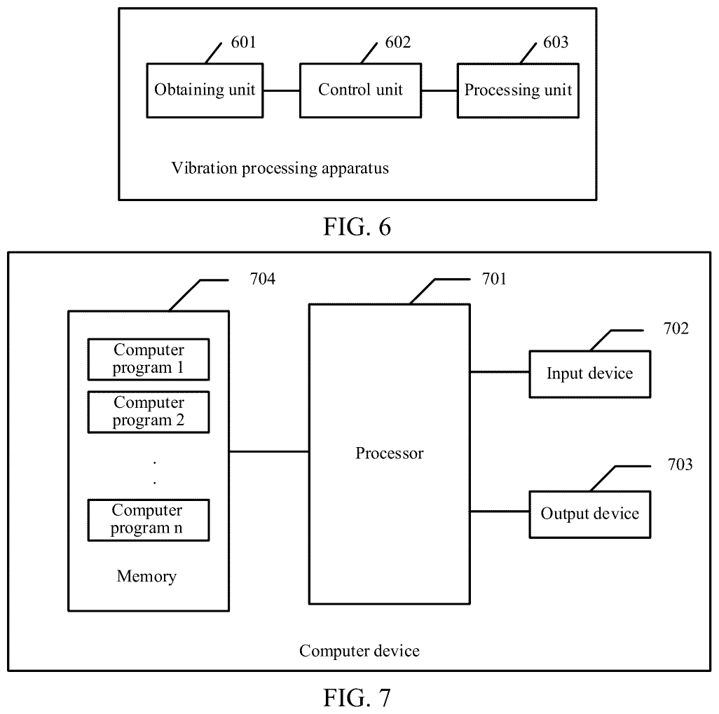

Referring to FIG. 6, FIG. 6 is a schematic structural diagram of a vibration processing apparatus according to an embodiment of the present disclosure. The vibration processing apparatus may be disposed in a computer device according to an embodiment of the present disclosure. For example, the computer device may be a terminal device mentioned in the foregoing method embodiments. The vibration processing apparatus shown in FIG. 6 may be a computer program (including program code) running in the computer device. The vibration processing apparatus may be configured to perform some or all operations in the method embodiments shown in FIG. 2 and FIG. 4. The vibration processing apparatus may include the following units.

An obtaining unit 601 is configured to obtain a current vibration fragment and coded information of the current vibration fragment from a vibration file of media data. The vibration file includes one or more vibration fragments, and any vibration fragment corresponds to a media fragment of the media data. The coded information of the current vibration fragment is configured for identifying a position of the current vibration fragment in the vibration file.

The control unit 602 is configured to control to output a current vibration based on the coded information of the current vibration fragment. When the current vibration is outputted, a media fragment corresponding to the current vibration fragment is outputted.

In one embodiment, the coded information includes: a fragment quantity field, where the fragment quantity field is configured for indicating a total quantity of fragments corresponding to the one or more vibration fragments included in the vibration file; and when a value of the fragment quantity field is greater than 1, the vibration file is split into a plurality of vibration fragments, and when the value of the fragment quantity field is equal to 1, the vibration file is not split.

In one embodiment, the one or more vibration fragments included in the vibration file are arranged in sequence, and a vibration corresponding to any vibration fragment is outputted according to a corresponding sequence. The coded information includes a fragment sequence number field. The fragment sequence number field is configured for indicating a sequence number of the current vibration fragment in the vibration file. The sequence number is configured for indicating an output sequence of a corresponding vibration of the current vibration fragment. If a value of the fragment sequence number field of the current vibration fragment is equal to a value of the fragment quantity field of the current vibration fragment, the current vibration fragment is the last vibration fragment in the one or more vibration fragments arranged in sequence.

In one embodiment, the coded information includes: a fragment identification field, where the fragment identification field is configured for indicating an identification sequence number of the current vibration fragment; and the identification sequence number is associated with an application corresponding to the media data, and one application corresponds to one identification sequence number.

In one embodiment, the coded information includes a relative start time field. The relative start time field is configured for recording a vibration start time stamp of the current vibration fragment relative to a corresponding media fragment. The control unit is configured to: output, according to a play duration of the media fragment and a vibration parameter recorded in the coded information of the current vibration fragment, a current vibration equal to the play duration when the media fragment corresponding to the current vibration fragment is played to the vibration start time stamp.

In one embodiment, the current vibration outputted based on the current vibration fragment includes a vibration start stage, a vibration-in-process, and a vibration end stage. The vibration start stage of the current vibration fragment is configured for: starting to synchronize the outputted current vibration with the media fragment. The vibration-in-process of the current vibration fragment is configured for: performing vibration output according to the vibration parameter recorded in the coded information of the current vibration fragment. The vibration end stage of the current vibration fragment is configured for: making the outputted current vibration equal to the play duration.

In one embodiment, the position of the current vibration fragment in the vibration file includes any one of the following: a vibration start section, a vibration intermediate section, and a vibration end section. When the current vibration fragment is the vibration intermediate section, the vibration file includes at least three vibration fragments.

In one embodiment, when the current vibration fragment is in the vibration start stage and the current vibration fragment is the vibration intermediate section or the vibration end section,
the obtaining unit 601 is further configured to: obtain a vibration end state corresponding to a previous vibration fragment of the current vibration fragment, where the vibration end state is configured for indicating: whether a vibration corresponding to the previous vibration fragment ends normally; and
the control unit 602 is further configured to perform smooth vibration processing based on a vibration parameter of the previous vibration fragment if the vibration end state indicates that the vibration corresponding to the previous vibration fragment ends abnormally, and after smooth vibration is completed, control to output the vibration corresponding to the current vibration fragment when the media fragment corresponding to the current vibration fragment is played to the vibration start time stamp.

In one embodiment, when the current vibration fragment is in the vibration end stage, the control unit 602 is configured to:
keep, if a vibration end time stamp of the current vibration fragment is earlier than a play end time stamp of the media fragment corresponding to the current vibration fragment, a vibration effect of the current vibration fragment at the vibration end time stamp until the play end time stamp is reached;
stop outputting, when the current vibration fragment is the vibration start section or the vibration intermediate section if the vibration end time stamp of the current vibration fragment is later than the play end time stamp of the media fragment corresponding to the current vibration fragment, the current vibration when the current vibration fragment reaches the play end time stamp, and output a vibration corresponding to a next vibration fragment of the current vibration fragment; and
end the vibration if the vibration end time stamp of the current vibration fragment is later than the play end time stamp of the media fragment corresponding to the current vibration fragment when the current vibration fragment is the vibration end section.

In one embodiment, the obtaining unit 601 is configured to obtain a vibration file of the media data, where the vibration file is a file that records a continuous vibration. The processing unit 603 is configured to: determine one or more synchronization time stamps of the vibration file from the media data; and split the vibration file according to the synchronization time stamps, to obtain a plurality of vibration fragments of the vibration file.

In one embodiment, the processing unit 603 is configured to: align the vibration file with the media data according to a vibration start time stamp of the media data, where a vibration time stamp recorded in the aligned vibration file corresponds to a play time stamp in the media data; perform synchronization point identification processing on the media data, to determine a synchronization reference time stamp from the media data; and determine, based on a correspondence between play time stamps and vibration time stamps, a vibration time stamp corresponding to the synchronization reference time stamp from the vibration file, and use the determined vibration time stamp as the synchronization time stamp determined from the vibration file.

In one embodiment, when the media data includes audio data or video data, the processing unit 603 is configured to: determine reference media data corresponding to the vibration file from the media data; and obtain a data difference between two neighboring frames in the reference media data, and use a play time stamp corresponding to a previous frame in the two neighboring frames as one synchronization reference time stamp when the data difference reaches a difference threshold. If the media data includes the audio data, the data difference reaching the difference threshold means that: an audio difference between two neighboring frames reaches a first difference threshold. If the media data includes the video data, the data difference reaching the difference threshold means that: a picture difference between two neighboring frames reaches a second difference threshold.

In one embodiment, when the media data is game data, the game data includes one or more skill operation data in a game. The processing unit 603 is configured to: obtain operation time stamps corresponding to the skill operation data in the game data; and use, when any skill operation data corresponds to at least two operation time stamps, the at least two operation time stamps corresponding to any skill operation data as synchronization reference time stamps.

In one embodiment, the processing unit 603 is configured to: obtain a reference duration; and perform synchronization point identification processing on the media data according to the reference duration, to obtain the corresponding synchronization reference time stamp.

In one embodiment, the processing unit 603 is further configured to: determine a type of the continuous vibration recorded in the vibration file; and split the vibration file if the type of the continuous vibration is a first type, so that the vibration file includes a plurality of vibration fragments. The first type of continuous vibration is a continuous vibration corresponding to a vibration duration greater than or equal to a preset threshold. If the type of the continuous vibration is a second type, the vibration file includes one vibration fragment and the second type of continuous vibration is a continuous vibration corresponding to a vibration duration less than the preset threshold. When the vibration file includes one vibration fragment, the coded information includes a triggering time stamp for triggering to output the continuous vibration.

In this embodiment of the present disclosure, a current vibration fragment and coded information of the current vibration fragment may be obtained from a vibration file of media data. The vibration file includes one or more vibration fragments, and one vibration fragment corresponds to a media fragment of the media data. It can be seen that there is a correspondence between vibration fragments in the vibration file and media fragments in the media data. The correspondence may ensure that the vibration fragments are conforming to the media fragments. The coded information of the current vibration fragment may be configured for identifying a position of the current vibration fragment in the vibration file, a current vibration may be controlled to be outputted based on the coded information of the current vibration fragment, and when the current vibration is outputted, a media fragment corresponding to the current vibration fragment may be outputted. It can be seen that output of the corresponding vibration of the current vibration fragment may be controlled based on the coded information of the current vibration fragment, and the current vibration and the corresponding media fragment are synchronously outputted. If the vibration file includes a plurality of vibration fragments, the vibration output is fragmented, and vibrations corresponding to the vibration fragments in the vibration file can be synchronously outputted with the corresponding media fragments under an indication of the coded information. In addition, the output of the corresponding vibration may be flexibly controlled based on the coded information for vibration fragments at different positions in the vibration file. The vibration of each fragment is synchronized with the output of the media fragment, so that synchronization of overall vibration and media can be ensured, thereby providing more immersive experience for an object.

An embodiment of the present disclosure further provides a schematic structural diagram of a computer device (e.g., a computing device). The schematic structural diagram of the computer device may be seen in FIG. 7. The computer device may include: a processor 701, an input device 702, an output device 703, and a memory 704. The processor 701, the input device 702, the output device 703, and the memory 704 are connected via a bus. The memory 704 is configured to store a computer program. The computer program includes program instructions. The processor 701 is configured to execute the program instructions stored in the memory 704.

In one embodiment, the computer device may be the terminal device or the server in the system shown in FIG. 1. In this embodiment, the processor 701 performs the following operations by running the executable program code in the memory 704:
obtaining a current vibration fragment and coded information of the current vibration fragment from a vibration file of media data, where the vibration file includes one or more vibration fragments, any vibration fragment corresponds to a media fragment of the media data, and the coded information of the current vibration fragment is configured for identifying a position of the current vibration fragment in the vibration file; and
controlling to output a current vibration based on coded information of a current vibration fragment, where when the current vibration is outputted, a media fragment corresponding to the current vibration fragment is outputted.

In one embodiment, the coded information includes: a fragment quantity field, where the fragment quantity field is configured for indicating a total quantity of fragments corresponding to the one or more vibration fragments included in the vibration file; and when a value of the fragment quantity field is greater than 1, the vibration file is split into a plurality of vibration fragments, and when the value of the fragment quantity field is equal to 1, the vibration file is not split.

In one embodiment, the one or more vibration fragments included in the vibration file are arranged in sequence, and a vibration corresponding to any vibration fragment is outputted according to a corresponding sequence. The coded information includes a fragment sequence number field. The fragment sequence number field is configured for indicating a sequence number of the current vibration fragment in the vibration file. The sequence number is configured for indicating an output sequence of a corresponding vibration of the current vibration fragment. If a value of the fragment sequence number field of the current vibration fragment is equal to a value of the fragment quantity field of the current vibration fragment, the current vibration fragment is the last vibration fragment in the one or more vibration fragments arranged in sequence.

In one embodiment, the coded information includes: a fragment identification field, where the fragment identification field is configured for indicating an identification sequence number of the current vibration fragment; and the identification sequence number is associated with an application corresponding to the media data, and one application corresponds to one identification sequence number.

In one embodiment, the coded information includes a relative start time field. The relative start time field is configured for recording a vibration start time stamp of the current vibration fragment relative to a corresponding media fragment. A control unit is configured to: output, according to a play duration of the media fragment and a vibration parameter recorded in the coded information of the current vibration fragment, a current vibration equal to the play duration when the media fragment corresponding to the current vibration fragment is played to the vibration start time stamp.

In one embodiment, the current vibration outputted based on the current vibration fragment includes a vibration start stage, a vibration-in-process, and a vibration end stage. The vibration start stage of the current vibration fragment is configured for: starting to synchronize the outputted current vibration with the media fragment. The vibration-in-process of the current vibration fragment is configured for: performing vibration output according to the vibration parameter recorded in the coded information of the current vibration fragment. The vibration end stage of the current vibration fragment is configured for: making the outputted current vibration equal to the play duration.

In one embodiment, the position of the current vibration fragment in the vibration file includes any one of the following: a vibration start section, a vibration intermediate section, and a vibration end section. When the current vibration fragment is the vibration intermediate section, the vibration file includes at least three vibration fragments.

In one embodiment, when the current vibration fragment is in the vibration start stage and the current vibration fragment is the vibration intermediate section or the vibration end section,

The processor 701 is further configured to: obtain a vibration end state corresponding to a previous vibration fragment of the current vibration fragment, where the vibration end state is configured for indicating: whether a vibration corresponding to the previous vibration fragment ends normally.

The processor 701 is further configured to: perform smooth vibration processing based on a vibration parameter of the previous vibration fragment if the vibration end state indicates that the vibration corresponding to the previous vibration fragment ends abnormally, and after smooth vibration is completed, control to output the vibration corresponding to the current vibration fragment when the media fragment corresponding to the current vibration fragment is played to the vibration start time stamp.

In one embodiment, when the current vibration fragment is in the vibration end stage, the processor 701 is configured to:
keep, if a vibration end time stamp of the current vibration fragment is earlier than a play end time stamp of the media fragment corresponding to the current vibration fragment, a vibration effect of the current vibration fragment at the vibration end time stamp until the play end time stamp is reached;
stop outputting, when the current vibration fragment is the vibration start section or the vibration intermediate section if the vibration end time stamp of the current vibration fragment is later than the play end time stamp of the media fragment corresponding to the current vibration fragment, the current vibration when the current vibration fragment reaches the play end time stamp, and output a vibration corresponding to a next vibration fragment of the current vibration fragment; and
end the vibration if the vibration end time stamp of the current vibration fragment is later than the play end time stamp of the media fragment corresponding to the current vibration fragment when the current vibration fragment is the vibration end section.

In one embodiment, the processor 701 is configured to obtain a vibration file of the media data, where the vibration file is a file that records a continuous vibration. The processor 701 is configured to: determine one or more synchronization time stamps of the vibration file from the media data; and split the vibration file according to the synchronization time stamps, to obtain a plurality of vibration fragments of the vibration file.

In one embodiment, the processor 701 is configured to: align the vibration file with the media data according to a vibration start time stamp of the media data, where a vibration time stamp recorded in the aligned vibration file corresponds to a play time stamp in the media data; perform synchronization point identification processing on the media data, to determine a synchronization reference time stamp from the media data; and determine, based on a correspondence between play time stamps and vibration time stamps, a vibration time stamp corresponding to the synchronization reference time stamp from the vibration file, and use the determined vibration time stamp as the synchronization time stamp determined from the vibration file.

In one embodiment, when the media data includes audio data or video data, the processor 701 is configured to: determine reference media data corresponding to the vibration file from the media data; and obtain a data difference between two neighboring frames in the reference media data, and use a play time stamp corresponding to a previous frame in the two neighboring frames as one synchronization reference time stamp when the data difference reaches a difference threshold. If the media data includes the audio data, the data difference reaching the difference threshold means that: an audio difference between two neighboring frames reaches a first difference threshold. If the media data includes the video data, the data difference reaching the difference threshold means that: a picture difference between two neighboring frames reaches a second difference threshold.

In one embodiment, when the media data is game data, the game data includes one or more skill operation data in a game. The processor 701 is configured to: obtain operation time stamps corresponding to the skill operation data in the game data; and use, when any skill operation data corresponds to at least two operation time stamps, the at least two operation time stamps corresponding to any skill operation data as synchronization reference time stamps.

In one embodiment, the processor 701 is configured to: obtain a reference duration; and perform synchronization point identification processing on the media data according to the reference duration, to obtain the corresponding synchronization reference time stamp.

In one embodiment, the processor 701 is further configured to: determine a type of the continuous vibration recorded in the vibration file; and split the vibration file if the type of the continuous vibration is a first type, so that the vibration file includes a plurality of vibration fragments. The first type of continuous vibration is a continuous vibration corresponding to a vibration duration greater than or equal to a preset threshold. If the type of the continuous vibration is a second type, the vibration file includes one vibration fragment and the second type of continuous vibration is a continuous vibration corresponding to a vibration duration less than the preset threshold. When the vibration file includes one vibration fragment, the coded information includes a triggering time stamp for triggering to output the continuous vibration.

In this embodiment of the present disclosure, a current vibration fragment and coded information of the current vibration fragment may be obtained from a vibration file of media data. The vibration file includes one or more vibration fragments, and one vibration fragment corresponds to a media fragment of the media data. It can be seen that there is a correspondence between vibration fragments in the vibration file and media fragments in the media data. The correspondence may ensure that the vibration fragments are conforming to the media fragments. The coded information of the current vibration fragment may be configured for identifying a position of the current vibration fragment in the vibration file, a current vibration may be controlled to be outputted based on the coded information of the current vibration fragment, and when the current vibration is outputted, a media fragment corresponding to the current vibration fragment may be outputted. It can be seen that output of the corresponding vibration of the current vibration fragment may be controlled based on the coded information of the current vibration fragment, and the current vibration and the corresponding media fragment are synchronously outputted. If the vibration file includes a plurality of vibration fragments, the vibration output is fragmented, and vibrations corresponding to the vibration fragments in the vibration file can be synchronously outputted with the corresponding media fragments under an indication of the coded information. In addition, the output of the corresponding vibration may be flexibly controlled based on the coded information for vibration fragments at different positions in the vibration file. The vibration of each fragment is synchronized with the output of the media fragment, so that synchronization of overall vibration and media can be ensured, thereby providing more immersive experience for an object.

In addition, an embodiment of the present disclosure further provides a computer-readable storage medium. The computer-readable storage medium has a computer program stored therein, and the computer program includes program instructions. When executing the program instructions, the processor can perform the methods in the foregoing embodiments corresponding to FIG. 2 and FIG. 4. Therefore, details are not described herein again. For technical details that are not disclosed in the computer-readable storage medium embodiments of the present disclosure, refer to the descriptions of the method embodiments of the present disclosure. As an example, the program instructions may be deployed to be executed on a computer device, or deployed to be executed on a plurality of computer devices at the same location, or deployed to be executed on a plurality of computer devices that are distributed in a plurality of locations and interconnected by using a communication network.

In another aspect of the present disclosure, a computer program product is provided. The computer program product includes a computer program. The computer program is stored in a computer-readable storage medium. A processor of a computer device reads the computer program from the computer-readable storage medium. The processor executes the computer program, so that the computer device may perform the methods in the foregoing embodiments corresponding to FIG. 2 and FIG. 4. Therefore, details are not described herein again.

A person of ordinary skill in the art may understand that all or some of the procedures of the methods of the foregoing embodiments may be implemented by a computer program instructing relevant hardware. The program may be stored in a computer-readable storage medium. When the program is executed, the procedures of the foregoing method embodiments may be implemented. The foregoing storage medium may include a magnetic disc, an optical disc, a read-only memory (ROM), a random access memory (RAM), or the like.

The content disclosed above is merely examples of the present disclosure, and is not intended to limit the scope of claims of the present disclosure. A person of ordinary skill in the art may understand all or a part of the procedures for implementing the foregoing embodiments, and any equivalent variation made based on the claims of the present disclosure shall still fall within the scope of the present disclosure.

What is claimed is:

1. A vibration processing method, comprising:
obtaining, by a computing device, a current vibration fragment and coded information of the current vibration fragment from a vibration file of media data, wherein the vibration file comprises one or more vibration fragments, each vibration fragment corresponds to a media fragment of the media data, the current vibration fragment is one of the one or more vibration fragments comprised in the vibration file, and wherein the coded information of the current vibration fragment is configured for identifying a position of the current vibration fragment in the vibration file; and
controlling to output a current vibration based on the coded information of the current vibration fragment, wherein based on the current vibration being outputted, a media fragment corresponding to the current vibration fragment is outputted.

2. The method according to claim 1, wherein the coded information comprises: a fragment quantity field, wherein the fragment quantity field is configured for indicating a total quantity of fragments corresponding to the one or more vibration fragments comprised in the vibration file, and
wherein based on a value of the fragment quantity field being greater than 1, the vibration file is split into a plurality of vibration fragments, and based on the value of the fragment quantity field being equal to 1, the vibration file is not split.

3. The method according to claim 1, wherein the one or more vibration fragments comprised in the vibration file are arranged in sequence, and a vibration corresponding to one of the one or more vibration fragments is outputted according to a corresponding sequence,
wherein the coded information comprises a fragment sequence number field, wherein the fragment sequence number field is configured for indicating a sequence number of the current vibration fragment in the vibration file, and the sequence number is configured for indicating an output sequence of a corresponding vibration of the current vibration fragment, and
wherein based on a value of the fragment sequence number field of the current vibration fragment being equal to a value of a fragment quantity field of the current vibration fragment, the current vibration fragment is the last vibration fragment in the one or more vibration fragments arranged in sequence.

4. The method according to claim 1, wherein the coded information comprises: a fragment identification field, wherein the fragment identification field is configured for indicating an identification sequence number of the current vibration fragment, and
wherein the identification sequence number is associated with an application corresponding to the media data, and one application corresponds to one identification sequence number.

5. The method according to claim 1, wherein the coded information comprises a relative start time field, and the relative start time field is configured for recording a vibration start time stamp of the current vibration fragment relative to a corresponding media fragment, and the controlling to output the current vibration based on the coded information of the current vibration fragment comprises:
outputting, according to a play duration of the media fragment and a vibration parameter recorded in the coded information of the current vibration fragment, a current vibration equal to the play duration based on the media fragment corresponding to the current vibration fragment being played to the vibration start time stamp.

6. The method according to claim 5, wherein the output of the current vibration based on the coded information of the current vibration fragment comprises a vibration start stage, a vibration-in-process, and a vibration end stage,
wherein the vibration start stage of the current vibration fragment is configured for: starting to synchronize the outputted current vibration with the media fragment,
wherein the vibration-in-process of the current vibration fragment is configured for: performing the output of the current vibration according to the vibration parameter recorded in the coded information of the current vibration fragment, and
wherein the vibration end stage of the current vibration fragment is configured for: making the outputted current vibration equal to the play duration.

7. The method according to claim 5, wherein the position of the current vibration fragment in the vibration file comprises one of the following: a vibration start section, a vibration intermediate section, and a vibration end section,
wherein based on the current vibration fragment being the vibration intermediate section, the vibration file comprises at least three vibration fragments.

8. The method according to claim 7, wherein the output of the current vibration based on the coded information of the current vibration fragment comprises a vibration start stage, a vibration-in-process, and a vibration end stage, wherein based on the current vibration fragment being in the vibration start stage and the current vibration fragment being the vibration intermediate section or the vibration end section, the method further comprises:
obtaining a vibration end state corresponding to a previous vibration fragment of the current vibration fragment, wherein the vibration end state is configured for indicating: whether a vibration corresponding to the previous vibration fragment ends normally; and
performing a smooth vibration processing based on a vibration parameter of the previous vibration fragment based on the vibration end state indicating that the vibration corresponding to the previous vibration fragment ends abnormally, and after the smooth vibration processing is completed, controlling to output the current vibration corresponding to the current vibration fragment based on the media fragment corresponding to the current vibration fragment being played to the vibration start time stamp.

9. The method according to claim 7, wherein based on the current vibration fragment being in the vibration end stage, the outputting, according to the play duration of the media fragment and the vibration parameter recorded in the coded information of the current vibration fragment, the current vibration equal to the play duration comprises:
keeping, based on a vibration end time stamp of the current vibration fragment being earlier than a play end time stamp of the media fragment corresponding to the current vibration fragment, a vibration effect of the current vibration fragment at the vibration end time stamp until the play end time stamp is reached;
stopping outputting, based on the current vibration fragment being the vibration start section or the vibration intermediate section based on the vibration end time stamp of the current vibration fragment being later than the play end time stamp of the media fragment corresponding to the current vibration fragment, the current vibration based on the current vibration fragment reaching the play end time stamp, and outputting a vibration corresponding to a next vibration fragment of the current vibration fragment; and
ending the vibration based on the vibration end time stamp of the current vibration fragment being later than the play end time stamp of the media fragment corresponding to the current vibration fragment based on the current vibration fragment being the vibration end section.

10. The method according to claim 1, the method further comprising:
obtaining the vibration file of the media data, wherein the vibration file records a continuous vibration;
determining one or more synchronization time stamps of the vibration file from the media data; and
splitting the vibration file according to the synchronization time stamps, to obtain a plurality of vibration fragments of the vibration file.

11. The method according to claim 10, wherein the determining the one or more synchronization time stamps of the vibration file from the media data comprises:
aligning the vibration file with the media data according to a vibration start time stamp of the media data, a vibration time stamp recorded in the aligned vibration file corresponding to a play time stamp in the media data;
performing a synchronization point identification processing on the media data, to determine a synchronization reference time stamp from the media data; and
determining, based on a correspondence between play time stamps and vibration time stamps, a vibration time stamp corresponding to the synchronization reference time stamp from the vibration file, and using the determined vibration time stamp as the synchronization time stamp determined from the vibration file.

12. The method according to claim 11, wherein based on the media data comprising audio data or video data, the performing the synchronization point identification processing on the media data, to determine the synchronization reference time stamp from the media data comprises:
determining reference media data corresponding to the vibration file from the media data; and
obtaining a data difference between two neighboring frames in the reference media data, and using a play time stamp corresponding to a previous frame in the two neighboring frames as one synchronization reference time stamp based on the data difference reaching a difference threshold,
wherein based on the media data comprising the audio data, the data difference reaching the difference threshold indicates that: an audio difference between the two neighboring frames reaches a first difference threshold; and based on the media data comprising the video data, the data difference reaching the difference threshold indicates that: a picture difference between the two neighboring frames reaches a second difference threshold.

13. The method according to claim 11, wherein based on the media data being game data, the game data comprises skill operation data in a game; and the performing the synchronization point identification processing on the media data, to determine the synchronization reference time stamp from the media data comprises:
obtaining operation time stamps corresponding to the skill operation data in the game; and
using, based on one piece of the skill operation data corresponds to at least two operation time stamps, the at least two operation time stamps corresponding to the one piece of the skill operation data as synchronization reference time stamps.

14. The method according to claim 11, wherein the performing the synchronization point identification processing on the media data, to determine the synchronization reference time stamp from the media data comprises:
obtaining a reference duration; and
performing the synchronization point identification processing on the media data according to the reference duration, to obtain the corresponding synchronization reference time stamp.

15. The method according to claim 10, the method further comprising:
determining a type of the continuous vibration recorded in the vibration file; and
splitting the vibration file based on the type of the continuous vibration being a first type, so that the vibration file comprises a plurality of vibration fragments, wherein the first type of continuous vibration is a continuous vibration corresponding to a vibration duration greater than or equal to a preset threshold,
wherein based on the type of the continuous vibration being a second type, the vibration file comprises one vibration fragment and the second type of continuous vibration is a continuous vibration corresponding to a vibration duration less than the preset threshold, and wherein based on the vibration file comprising one vibration fragment, the coded information comprises a triggering time stamp for triggering to output the continuous vibration.

16. A computing device, comprising:
one or more processors; and
memory stored instructions that, when executed by the one or more processors, cause the computing device to facilitate:
obtaining a current vibration fragment and coded information of the current vibration fragment from a vibration file of media data, wherein the vibration file comprises one or more vibration fragments, each vibration fragment corresponds to a media fragment of the media data, the current vibration fragment is one of the one or more vibration fragments comprised in the vibration file, and wherein the coded information of the current vibration fragment is configured for identifying a position of the current vibration fragment in the vibration file; and
controlling to output a current vibration based on the coded information of the current vibration fragment, wherein based on the current vibration being outputted, a media fragment corresponding to the current vibration fragment is outputted.

17. The computing device according to claim 16, wherein the coded information comprises: a fragment quantity field, wherein the fragment quantity field is configured for indicating a total quantity of fragments corresponding to the one or more vibration fragments comprised in the vibration file, and
wherein based on a value of the fragment quantity field being greater than 1, the vibration file is split into a plurality of vibration fragments, and based on the value of the fragment quantity field being equal to 1, the vibration file is not split.

18. The computing device according to claim 16, wherein the one or more vibration fragments comprised in the vibration file are arranged in sequence, and a vibration corresponding to one of the one or more vibration fragments is outputted according to a corresponding sequence,
wherein the coded information comprises a fragment sequence number field, wherein the fragment sequence number field is configured for indicating a sequence number of the current vibration fragment in the vibration file, and the sequence number is configured for indicating an output sequence of a corresponding vibration of the current vibration fragment, and
wherein based on a value of the fragment sequence number field of the current vibration fragment being equal to a value of a fragment quantity field of the current vibration fragment, the current vibration fragment is the last vibration fragment in the one or more vibration fragments arranged in sequence.

19. The computing device according to claim 16, wherein the coded information comprises: a fragment identification field, wherein the fragment identification field is configured for indicating an identification sequence number of the current vibration fragment, and
wherein the identification sequence number is associated with an application corresponding to the media data, and one application corresponds to one identification sequence number.

20. A non-transitory computer-readable storage medium, having computer-executable instructions stored therein, the computer-executed instructions, when executed by one or more processors of a computing device, cause the computing device to facilitate:
obtaining a current vibration fragment and coded information of the current vibration fragment from a vibration file of media data, wherein the vibration file comprises one or more vibration fragments, each vibration fragment corresponds to a media fragment of the media data, the current vibration fragment is one of the one or more vibration fragments comprised in the vibration file, and wherein the coded information of the current vibration fragment is configured for identifying a position of the current vibration fragment in the vibration file; and
controlling to output a current vibration based on the coded information of the current vibration fragment, wherein based on the current vibration being outputted, a media fragment corresponding to the current vibration fragment is outputted.
